(19) United States
(12) Patent Application Publication
(10) Pub. No.: US 2014/0136346 A1
(43) Pub. Date: May 15, 2014

(54) SYSTEM AND METHODS FOR PROCESSING IN-STREAM TRANSACTIONS ON MICRO-BLOGS AND OTHER SOCIAL NETWORKS

(71) Applicant: Chirpify, Inc., Portland, OR (US)

(72) Inventor: Chris Teso, Portland, OR (US)

(73) Assignee: Chirpify, Inc., Portland, OR (US)

(21) Appl. No.: 14/079,609

(22) Filed: Nov. 13, 2013

Related U.S. Application Data
(60) Provisional application No. 61/725,955, filed on Nov. 13, 2012.

(51) Int. Cl. G06Q 50/00; G06Q 30/02; G06Q 20/10

(52) U.S. Cl. CPC G06Q 50/01; G06Q 20/10; G06Q 30/0276
USPC 705/14.72; 705/39

(57) ABSTRACT

System and methods for processing in-stream transactions on micro-blogs and other social networks (“in-stream transaction processing system”) facilitates transactions via comments, posts or messages on social networks. The in-stream transaction processing system converts social channels used for conversation into channels through which users can engage in commerce, fundraising or other non-financial activities. In an embodiment, the in-stream transaction processing system monitors user messages on a social network to determine whether a user message includes an action command and a campaign identifier. The in-stream transaction processing system identifies the user message having the action command and the campaign identifier as a request to process a transaction and processes the transaction accordingly. Since the users do not have to use shopping carts and checkouts, the in-stream transaction processing system provides a simple and frictionless method of conducting online transactions.

### CROSS-REFERENCE TO RELATED APPLICATION(S)

This application claims priority to and the benefit from U.S. Provisional Patent Application Ser. No. 61/725,955 entitled “Social Commerce and Payments Platform” (Attorney Docket No. 089086-8001.US00) filed on Nov. 13, 2012, the content of which is herein expressly incorporated by reference in its entirety.

### BACKGROUND

Websites such as EBAY, AMAZON and CRAIGSLIST are commonly used by buyers and sellers to buy or sell items online. However, there many hurdles to buying and selling through these traditional channels that can impact sales. For example, a seller who wants to sell an item on AMAZON.COM can upload his or listing to the AMAZON website. However, for the seller to make a sale, a potential buyer has to visit the AMAZON website, locate the seller's item by browsing or searching on the website, and add the item to a shopping cart. Even after the potential buyer has added the item to the shopping cart, the potential buyer can put off or change his or her decision to purchase the item, which can lead to shopping cart abandonment. If the potential buyer is determined to complete the purchase of the item, he or she has to log in to his or her AMAZON account, provide or select payment information, and review and submit the order for fulfillment. These extra steps involved in each purchase transaction through the traditional online sales channel can be cumbersome and can impede the purchase transaction. Moreover, if a seller wants to sell items through more than one channel (e.g., EBAY and AMAZON), the seller would have to maintain separate seller accounts for both channels, reconcile sales through the two channels, etc., which can be inconvenient.

In addition to the above disadvantages, these traditional channels have generally been used for limited types of transactions such as purchase and sale transactions, and cannot support other types of transactions. Overall, the examples provided herein of some prior or related systems and their associated limitations are intended to be illustrative and not exclusive. Other limitations of existing or prior systems will become apparent to those of skill in the art upon reading the following Detailed

### DESCRIPTION

### BRIEF DESCRIPTION OF THE DRAWINGS

FIG. 1 is a data flow diagram illustrating an overview of processing of in-stream transactions in micro-blogs and other social networks.

FIG. 2 is a block diagram illustrating an overview of a cross-channel campaign over one or more media channels.

FIG. 3 is a diagram illustrating an example environment in which an in-stream transaction processing system is implemented.

FIG. 4A is a block diagram of the in-stream transaction processing system.

FIG. 4B is an example structure of a database coupled to the in-stream transaction processing system.

FIG. 5 is a block diagram illustrating an example method for creating a user account on the in-stream transaction processing system.

FIG. 6 is a logic flow diagram illustrating an example method of creating and publishing a campaign.

FIG. 7A is a functional diagram illustrating the process of creating a campaign from a social network application for distribution through one or more social network applications.

FIG. 7B is a functional diagram illustrating the process of updating a campaign from a website or application and publishing the campaign through one or more social network applications.

FIG. 8 is a logic flow diagram illustrating an example method of identifying and processing an in-stream transaction by the in-stream transaction processing system.

FIGS. 9A-9B are functional diagrams illustrating the process of identifying and completing an in-stream transaction and notifying transaction participants.

FIGS. 10A-B are diagrams illustrating graphical user interfaces of a dashboard that can be accessed to create a campaign and manage social identities.

FIGS. 11A-11B are diagrams illustrating graphical user interfaces of the in-stream transaction processing system application for creating a campaign, including digital content and receiving messages.

FIGS. 12A-12B are diagrams illustrating graphical user interfaces of social network applications displaying a listing and a comment that triggers an in-stream commerce transaction.

FIG. 13 is a diagram illustrating a graphical user interface displaying a post on a social network application that triggers an in-stream payment transaction.

FIGS. 14A-14B are diagrams illustrating graphical user interfaces displaying example posts that trigger in-stream fundraising transactions.

FIG. 15A is a diagram illustrating a graphical user interface of a dashboard displaying receipts of in-stream transactions on one or more social networks.

FIGS. 15A-15C are diagrams illustrating graphical user interfaces of a dashboard for managing campaigns and adding meta data to campaigns.

FIGS. 16A-16C are example diagrams illustrating graphical user interfaces of applications utilizing in-stream transaction processing.

FIG. 16D is an example diagram illustrating a graphical user interface of a website including a button to engage in an in-stream transaction processing.

FIG. 17A displays tables illustrating examples of action tags and campaign tags.

FIG. 17B displays a table illustrating example comments or posts and example responses to the comments or posts.

### DETAILED DESCRIPTION

A system and methods for processing in-stream transactions on micro-blogs and other social networks (hereinafter “in-stream transaction processing system”) are described herein. The in-stream transaction processing system provides a social, device agnostic, frictionless and one-step transaction platform to facilitate the execution of a desired transaction by a user. The system turns replies, comments, posts, messages, conversation or other expressions of user interaction with social media and messaging services into actionable events, thereby enabling individuals, businesses, organizations, or the like to buy, sell, donate, fundraise, poll or organize other campaigns on social media.

The in-stream transaction processing system detects and processes transactions that are triggered by the presence of certain action tags (i.e., system-defined keywords or commands) in conjunction with campaign tags (i.e., user-defined keywords or commands) in comments, posts, messages, tweets, and the like (each used interchangeably hereinafter). The comments, posts, messages, tweets, and the like may be detected by monitoring social networks such as micro-blogs (e.g., TWITTER), photo-sharing services and video-sharing services (e.g., INSTAGRAM), and social networking services (e.g., FACEBOOK).

Various implementations of the invention will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

### 1. OVERVIEW OF IN-STREAM TRANSACTION PROCESSING

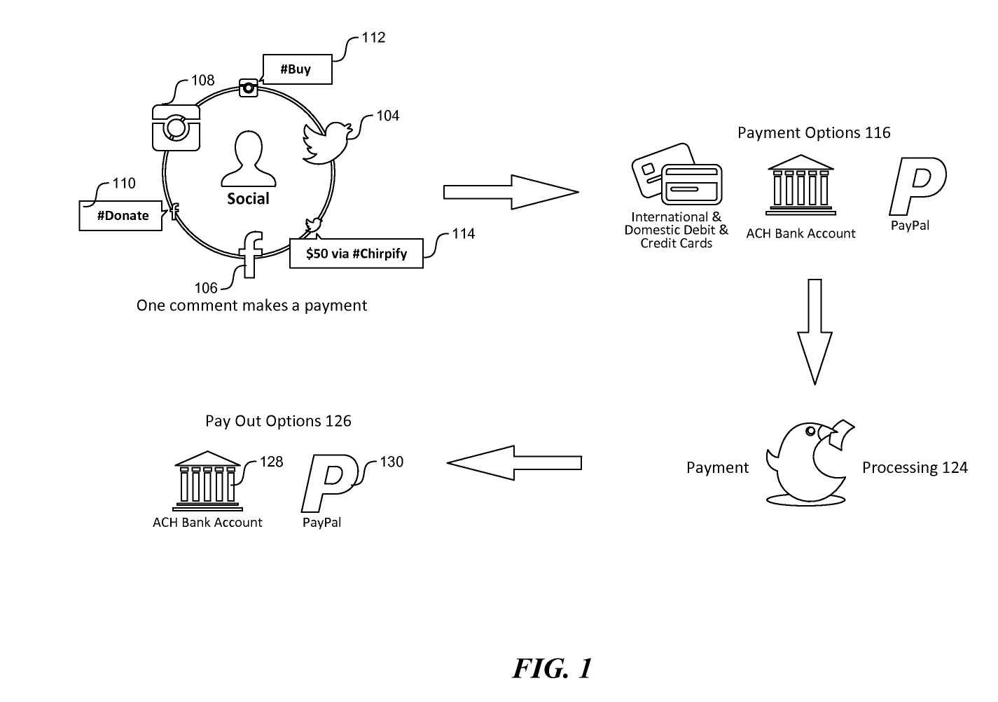

The data flow diagram of FIG. 1 provides an overview of processing of in-stream transactions, including commerce, fundraising and direct payment transactions, by the in-stream transaction processing system. The system monitors comments or posts made by a user 102 via social networks or micro-blogging services such as TWITTER 104, FACEBOOK 106 and INSTAGRAM 108. As illustrated, the detection by the system of comments or posts containing certain action tags such as “buy” 112, “pay” and “donate” 110 in combination with campaign tags (e.g., “Chirpify,” “EradicatePolio”) can trigger a transaction to occur. When a transaction involves a payment, a payment option 116 corresponding to the user 102 can be identified or obtained for payment processing 124 by the system. The in-stream transaction processing system may accept various payment options 116 such as international and national debit and card credit cards, ACH bank accounts, PAYPAL, and the like. Any of the payment options are processed via a payment gateway or payment processor. Following payment processing, the amount owed to one or more parties involved is paid out through the configured payout options 126 such as an ACH bank account, PAYPAL, etc. For example, when the user 102 tweets “#Pay @JDoe $100 via #Chirpify,” the in-stream payment processing system monitoring the user's tweets detects the presence of “#pay” and “#Chirpify” in the tweet. The system identifies the tweet as a direct payment type of transaction, based on the presence of the action tag “#pay”, and therefore identifies a payment option 116 associated with the payor. The system further identifies (or obtains) a payment option 116 associated with the payee. The system then processes the payment through a payment processor or gateway, such that the payor's financial account is debited an amount (e.g., $100 or $100 plus fees) and the payee's financial account is credited an amount (e.g., $100 minus fees or $100).

The in-stream transaction processing system provides a platform for individuals, businesses, organizations, or the like to create cross-channel campaigns that leverage one or more social and/or media channels and allow consumers to participate in such campaigns instantly. Campaign organizers can define campaign tags for campaigns, associate the campaigns with action tags and launch their campaigns in multiple media channels including, but not limited to, via traditional print media (e.g., magazines, newspapers), traditional video media (e.g., network television, cable TV, satellite TV), radio, online media (e.g., YOUTUBE, HULU), billboards and signs, and social networks. Users of social networks engage with the campaigns (e.g., by participating or transacting) by simply commenting or posting on their social networks using the action and campaign tags.

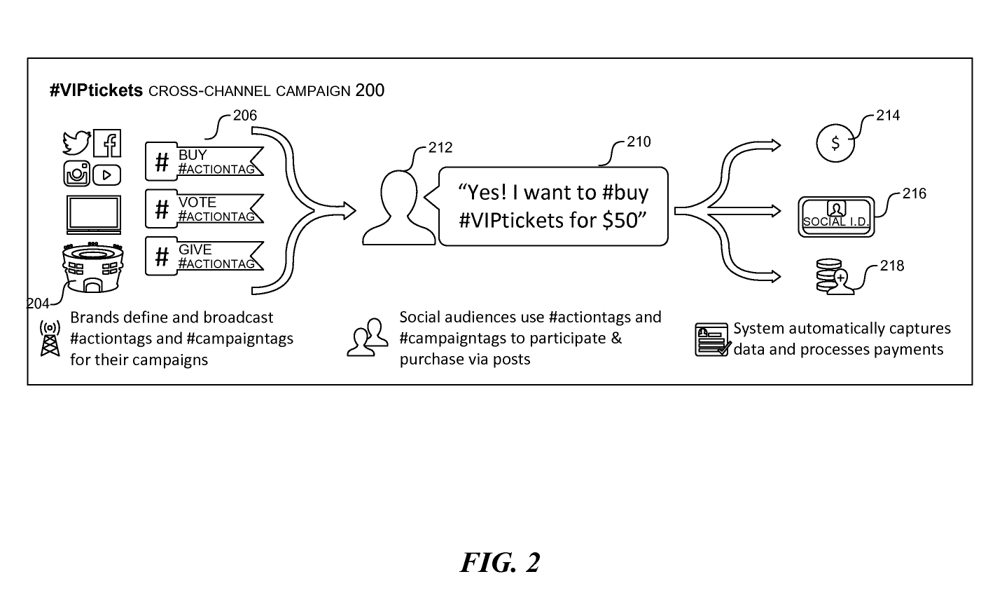

An example cross-channel campaign for selling tickets created using the in-stream transaction processing system is illustrated in FIG. 2. A campaign organizer logs into a website or other application supported by the in-stream transaction processing system and accesses a dashboard. The dashboard includes various tools to create one or more campaigns and promote the campaigns via multiple media channels 204. Example media channels include, but are not limited to: social media channels such as TWITTER, FACEBOOK, INSTAGRAM, YOUTUBE as well as traditional media channels such as television, billboard, print, radio, and the like. To create a campaign, the campaign organizer selects an action tag 206 from a list of available action tags. In this example, the campaign organizer is organizing a commercial campaign, and as such selects a “buy” action tag related to commercial activity. If the campaign were related to getting users to vote for something, a “vote” action tag would be selected. Similarly, a “give” action tag would be selected if the campaign were related to soliciting donations, etc. The campaign organizer also defines its own campaign tag such as “VIPtickets” to uniquely identify their brand or current offering to consumers. In this fashion, a campaign organizer may quickly construct a transaction opportunity that may be pushed to consumers.

Once the campaign is defined by a campaign organizer, the system publishes the campaign through media channels selected by the campaign organizer. Social audiences or users of social media channels use the action tag and campaign tag associated with the campaign to participate in the campaign via posts or comments. As shown in FIG. 2, a “buy” action tag and “VIPtickets” campaign tag have been activated in TWITTER for the campaign 200. When a TWITTER user 212 posts a tweet 210 including both the action and campaign tags for the campaign 200 (e.g., “Yes! I want to #buy #VIPtickets for $50”), the system automatically detects the tweet, obtains payment details linked to the user's social identity 216 (e.g., TWITTER ID) and processes the payment 214, such that the buyer's 212 financial account is debited and the seller's 218 financial account is credited.

### 2. SUITABLE COMPUTING ENVIRONMENT

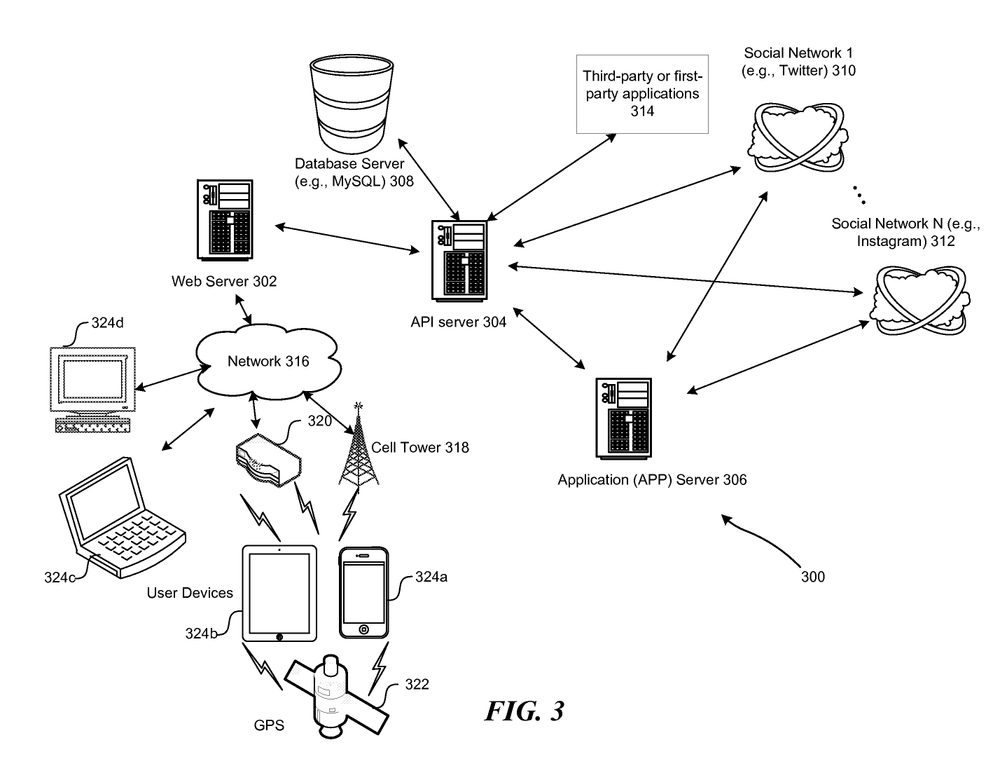

The in-stream transaction processing system may be implemented in a suitable computing environment 300 illustrated in FIG. 3. Although not required, aspects and implementations of the system will be described in the general context of computer-executable instructions, such as routines executed by a general-purpose computer, a personal computer, a server, or other computing systems. Embodiments of the system may also be embodied in a special purpose computer or data processor that is specifically programmed, configured, or constructed to perform one or more of the computer-executable instructions explained in detail herein. Indeed, the terms “computer” and “computing device,” as used generally herein, refer to devices that have one or more processors and non-transitory memory, like any of the above devices, as well as any data processor or any device capable of communicating with a network. Data processors include programmable general-purpose or special-purpose microprocessors, programmable controllers, application-specific integrated circuits (ASICs), programmable logic devices (PLD5), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

Embodiments of the in-stream transaction processing system may be implemented in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the ITP system described herein may be stored or distributed on tangible, non-transitory computer-readable media, including magnetic and optically readable and removable computer discs, stored in firmware in chips (e.g., EEPROM chips), an array of devices (e.g., Redundant Array of Independent Disks (RAID)), solid state memory devices (e.g., solid state drives (SSD), Universal Serial Bus (USB)), and/or the like. Alternatively, aspects of the ITP system may be distributed electronically over the Internet or over other networks (including wireless networks). Those skilled in the relevant art will recognize that portions of the system may reside on a server computer, while corresponding portions reside on a client computer. Data structures and transmission of data particular to aspects of the system are also encompassed within the scope of the invention.

The computing environment of FIG. 3 shows a multi-layered architecture that includes a web server 302, an API (Application Programming Interface) server 304, an APP (application) server 306 and a database server 308. The web server 302, the API server 304, database server 308 and the APP server 306 may exist in separate virtual private server (VPS) instances on separate machines to prevent a security intrusion on one layer (e.g., web service layer) to gain access to the API server layer or the APP server layer. It should be noted that in other embodiments, the system may be implemented based on other architectures. For example, functions of at least some of the servers may be consolidated.

The web server 302 (e.g., Apache web server) hosts a website and/or supports an application (each hereinafter “system website”) that includes a dashboard or similar graphical user interface for organizing and presenting information relating to campaigns, transactions, receipts, user account settings, financial account settings, social identities, etc. For example, via the system website, users create accounts, login, connect their social identities (e.g., TWITTER, FACEBOOK, INSTAGRAM, GOOGLE+), link their user accounts to financial accounts (e.g., debit cards, credit cards, prepaid cards, PAYPAL account, bank account), track, manage and view receipts/transactions, create and manage campaigns for sale, giveaway, donation, promotion, or the like, engage in transactions, and the like. User interactions on the system website lead to internal API endpoints, which then query the database server 308 and return a dataset (e.g., in JSON) or an appropriate error code. In other words, the web server 302 forwards end user requests to the API server 304, and displays the data returned by the API server 304.

The requests and responses exchanged between the web server 302 and client devices such as mobile phones 324a, tablets 324b, laptops 324c, desktop computers 324d, or the like over network 316 may be based on the HTTP (HyperText Transfer Protocol) over standard ports. Alternately, communication between the client devices and the web server 302 may be over other proprietary or non-proprietary protocols over standard or non-standard ports. Network 316 may include, but is not limited to: WiMax, the Internet, a Local Area Network (LAN), Wireless Local Area Network (WLAN), a Personal Area Network (PAN), a Campus Area Network (CAN), a Metropolitan Area Network (MAN), a Wide Area Network (WAN), a Wireless Wide Area Network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, IMT-Advanced, pre-4G, 3G LTE, 3GPP LTE, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1xRTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The API server 304 provides infrastructure for management, security, control, monitoring, and/or the like. In the architecture shown in FIG. 3, only the API server 304 has direct access to the database server 308 and as such, all database queries or operations are conducted through the API server 304. The API server 304 receives and internally routes end user requests/responses from the web server 302 and client requests/responses (e.g., from third-party or first-party applications (or application servers) 314, social networks 310, 312 and the like) to the database server 308 and/or the APP server 306. Users must have an API key to make requests of the API endpoints. For example, a third-party or first-party application 314 that is authorized to access all or a subset of the API functionality is provided a unique key to make requests of the API endpoints. Requests from users and third-party or first-party services are executed by the API server 304 only when a valid API key is included in the requests. All user and third-party or first-party service interactions with the API server 304 may be logged.

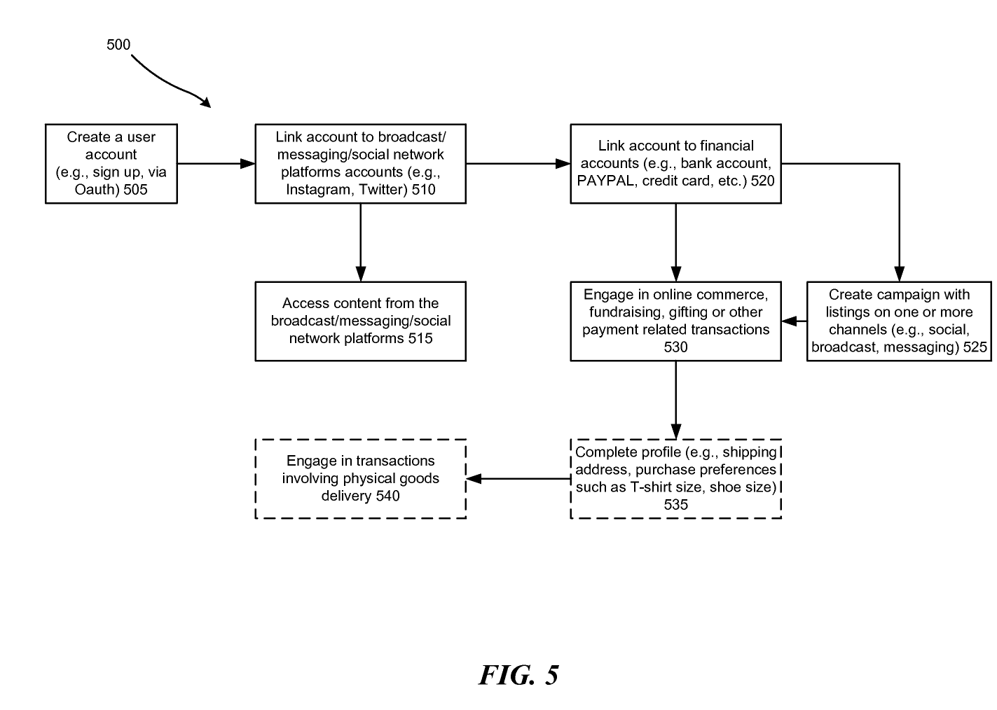

In the environment 300, the in-stream transaction processing system comprising the web server 302, the API server 304, the APP server 306 and the database server 308 are shown to be distinct from the social networks 310 and 312. In other words, the entities operating the in-stream transaction and the social network 310, for example, are different. Alternately, in one embodiment, the in-stream transaction processing system may be associated with or be a part of a social network (e.g., 310). In other words, TWITTER can implement the in-stream transaction processing methods (e.g., FIGS. 5, 6 and 8) to parse tweets of its users to identify transaction requests and process the transaction requests accordingly. Similarly, FACEBOOK can implement the in-stream transaction processing methods (e.g., FIGS. 5, 6 and 8) to identify wall posts, statuses, personal, group or instant messages of its users corresponding to transaction requests and process the transaction requests accordingly. Alternately, in another embodiment, the processing of in-stream transactions may be distributed between the in-stream transaction processing system and the social network server system(s).

In one embodiment, the API server 304 is a restful API server that handles all database requests. For example, the API server 304 parses GET or POST requests from clients and send the variables in the GET or POST requests to an internal uniform resource identifier (URI). API endpoints interact with the database server 308. If the query is successful, data is returned in JSON (or another suitable/specified format). If the query is not successful, a JSON response containing error codes may be output. Example error codes include: 200 (if request has correct arguments but record is not found), 400 (if request is missing argument or has malformed value of data (e.g., expected INT, but got CHAR), 403 (if correct key, but not the access level) and 404 (if endpoint not found, if incorrect method, if no API key, if invalid API key).

The APP server 306 supports the business logic and hosts the Redis server and PHP worker scripts. Real-time data received from the social network services 310, 312 are put into a Redis queue for asynchronous processing. The use of asynchronous workers and a Redis queue increases the system's ability to scale. Unlike storing jobs in a traditional relational database, there is no expense from writing to disk or acquiring table locks. Jobs are processed from the Redis queue in a first in, first out basis, by autonomous, forked workers. Each worker manages a specific, discrete task pulled from the Redis queue. For example, the workers parse comments or posts, create new campaigns, send messages (view email, tweets or comments) back to users, manage uploads, and the like. Assigning jobs to independent workers mitigates bottlenecks, as each worker's work load does not impact the rest of the system, and failure from worker to worker is segregated. Consequently, the autonomous architecture of the system expects and tolerates failure within the system but mitigates the impact of that failure. Failure from any job will not impact other workers, or the system at large.

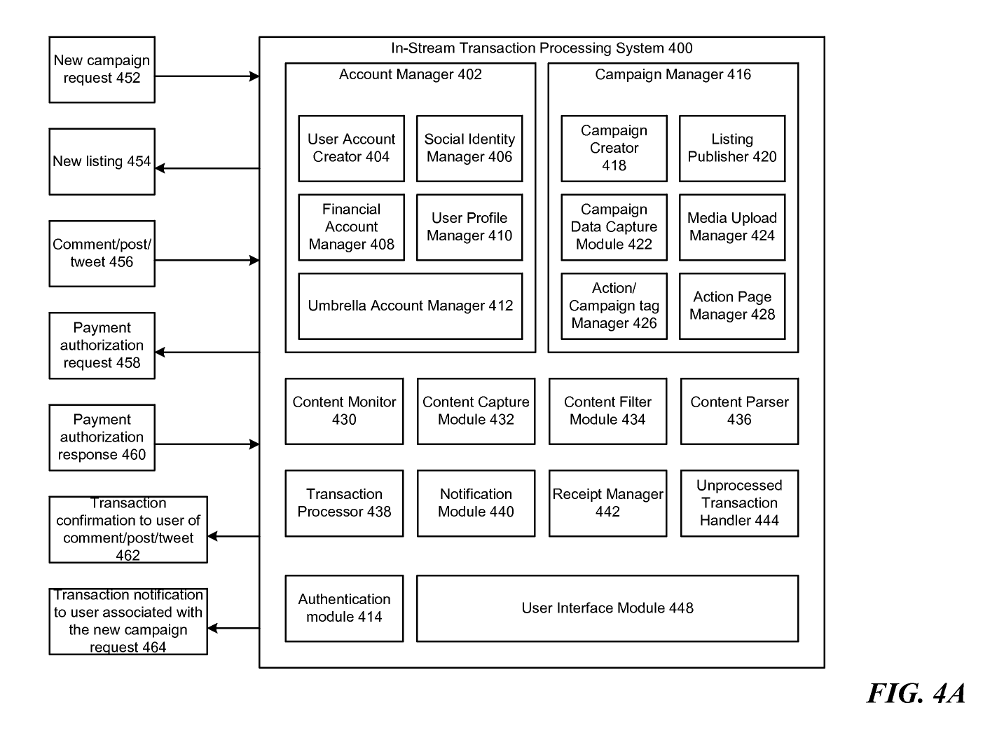

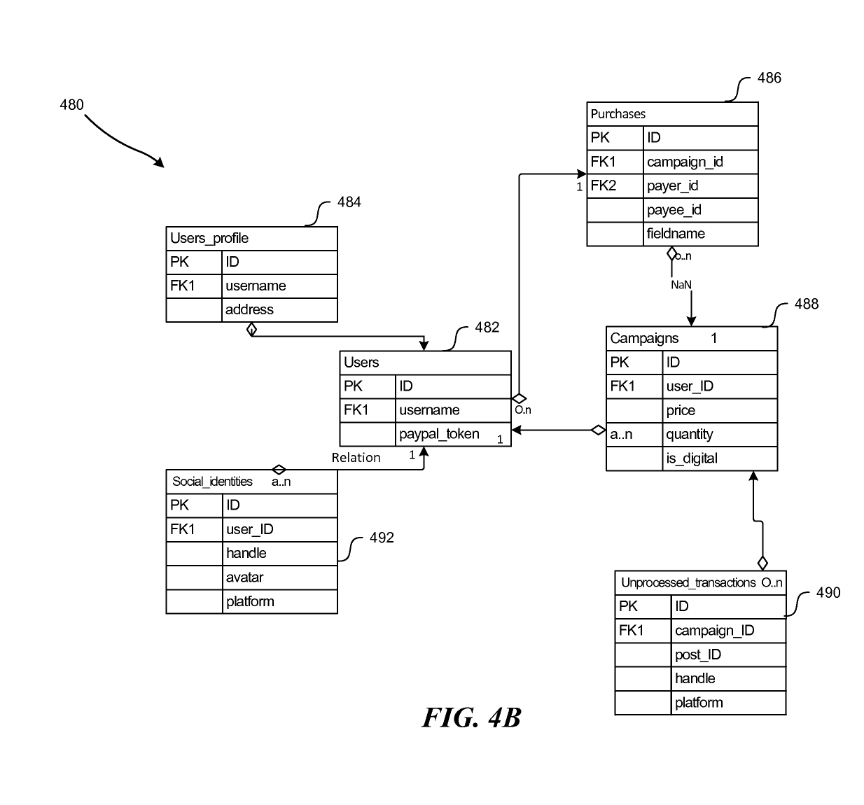

The system can also handle background tasks of varying length. An example is image processing. Once data are sent to an image processing worker, the data can be processed asynchronously from the rest of the application's work, and the system is not hostage to the amount of time it takes for the image processing to occur. The Resque library is used to as a conduit to the Redis queue to create background jobs, manage workers and place the jobs on queues. Various functions of or jobs performed by the APP server 306, the API server 304 and/or the web server 302 are described in detail in FIG. 4A. Further, the database structure including various tables and fields of data stored in the database server 308 is described in detail in FIG. 4B.

The in-stream transaction processing system implements various network security tools, policies, and/or network security solutions to protect the system from unauthorized intrusions, attacks, data interception, and the like. For example, the system supports transactions over HTTP as well as HTTPS (or any other secure protocols). By way of another example, API requests involving communication with third-party or first-party services (e.g., 310, 312, 314) are conducted over cryptographic protocols such as Secure Sockets Layer (SSL), Transport Layer Security (TLS) or the like. Similarly, the API server 304 acts as a firewall or barrier between the database server 308 and other servers or devices. Consequently, all query requests to the database server 308 (e.g., MySQL database) are routed through the API server 304, rather than the input coming directly from the web server 302. As a result, instead of raw GET or POST methods, sanitized data reach the database server 308. Having the API server 304 as a barrier to the database server 308 also ensures that an admin web user is the only account with permission to access the database server 308. Default web users cannot use Data Definition Language (DDL) to, for example, create, alter or drop tables. Default web users have privileges to only select, insert, update or delete records. Implementation of these data sanitization and strict API usage policies limit the vulnerability to SQL injection attacks.

In addition to network and database security, the in-stream transaction processing system also implements other security features to prevent malicious activity and protect data. For example, in one embodiment, the system selectively sanitizes data collected from the users of the system. Alternately, the system may sanitize all data collected from the users of the system. As used herein, data sanitization refers to a process of permanently and irreversibly destroying data stored on a memory device. By way of example, the system may not store highly sensitive data such as bank account identifiers, credit/debit card information or passwords for any accounts. By way of another example, integration with third-party or first-party services (e.g., TWITTER, INSTAGRAM, PAYPAL) is performed through a token-based system which stores a cryptographically secure hash. Since only the hashes are persisted and not the credentials themselves, users are requested to enter their credentials to validate requests. Data such as users' passwords may be randomly salted and stored in a one-way hash (e.g., using a variant of the Blowfish algorithm). If a user loses his or her password, a new password may need to be created. Similarly, queries for resources (e.g., requests to a URI which triggers a database query for persisted data) may also be sanitized or cleaned. All special characters may be removed from any user input, and any data passing through the system may be constrained to properties or policies defined by the system framework. To further protect the system servers, in one embodiment, access to all of the system servers is restricted to whitelisted Internet Protocol (IP) addresses. For example, the database server 308 may only accept queries from whitelisted IP addresses. In addition, the servers may only be accessed using cryptographic keys (e.g., RSA/Digital Signature Algorithm (DSA) keys) through Secure Shell (SSH). Only those who have their keys on the server-side may be able to gain access.

### 3. SUITABLE SYSTEMS

FIG. 4A is a block diagram of the in-stream transaction processing system 400 and some of the data that is received, processed or transformed and transmitted by the system. The system 400 may receive as input a request 452 from a user (e.g., an individual user, a business or organization user) to create a new campaign to sell items (e.g., products, services), giveaway items, raise funds, vote, get users to subscribe or enroll, provide offers, or the like. One or more modules of the system 400 create the campaign based on information provided by the user and publish a listing 454 associated with the campaign in one or more user-selected media channels including social networks.

The system 400, via one or more modules, detects a comment or post 456 on a social network or micro-blogging service and identifies the comment or post as an in-stream transaction request. The system 400 then sends a payment authorization request 458 to a payment processor or gateway (e.g., PAYPAL) if the in-stream transaction request includes a payment component. The system 400 obtains a payment authorization response 460 from the payment processor or gateway. If the payment authorization response is an approval, the system completes the in-stream transaction request and generates and sends a transaction notification 464 to the user who created the campaign associated with the listing and a transaction completion notification 462 to the user of the comment or post. The system 400 further accesses a database (e.g., database server 308 from FIG. 3) to retrieve and/or store some or all of the data received, processed and generated by the modules.

In one embodiment, the system 400 includes an account manager 402, a campaign manager 416, a content monitor 430, a content capture module 432, a content filter module 434, a content parser 436, a transaction processor 438, a notification module 4440, a receipt manager 442, an unprocessed transaction handler 444, an authentication module 414, a user interface module 448, or the like. In other embodiments, the system 400 may include more or less modules. For example, some of the modules of the system 400 may be consolidated into a single module, while others may be separated into multiple modules.

The account manager 402 creates and manages user accounts. For example, a user account creator 404 creates a user account in response to a user request. The user account creator 404 may create a user account based on user information such as a username, email address, phone number, password, or the like provided by the user. Alternately, when a user elects to sign up through a third-party service (e.g., FACEBOOK, TWITTER, INSTAGRAM), the authentication module 414 uses a standardized protocol such as OAuth supported by the third-party service to sign up (or authenticate) the user. The user is redirected to the login or authorization page of the selected third-party service, where the third-party service authenticates the user based on user credentials entered by the user and redirects the user back to the system website. The third-party service also issues a token to the system 400, which can be presented to the third-party service in future to obtain resources (e.g., comments, posts or other data relating to user activity on the third-party service platform). The user account creator 404 pulls in information about the user from the third-party service to create a user account. The authentication module 414 may also authenticate a user's PAYPAL or other similar financial account with the system (e.g., by using PAYPAL's authentication API).

The social identity manager 406 connects a user's account with one or more social networks selected by the user. For example, if the user wants to connect the account to TWITTER, the user is redirected to the TWITTER login page, where the user is asked to login and authorize the system 400 to access the user's TWITTER account (e.g., to receive user activity data, to post on the user's behalf). The financial account manager 408 accepts and manages payment information (e.g., bank account information, credit, debit or prepaid card information), settings or preferences (e.g., for purchases use Amex 1009, for fundraisers use BOA 556), and the like. The user profile manager 410 learns purchase history, preferences, behavioral attributes, social influence, social activities, and the like of a user and generates a user profile. The system 400 may then recommend or promote active or upcoming campaigns to users based on their user profiles.

The account manager 402 may also include an umbrella account manager 412 that allows a user to manage multiple entities (or brands) under a single umbrella account. For example, a record label can have a dozen artists under the label. Each artist can have their own campaigns (e.g., music distribution, sale of merchandise) under the artist account. The umbrella account manager 412 links the artist accounts to the label account, such that transactions and revenue can be managed at the label account level. For example, the label can access the label account to view transactions and revenues for each artist or view the aggregate transactions and revenues for all the artists under the label. The umbrella account manager 412 may also allow the label account to create different apportionment rules for distributing relevant portions of the revenue to the artists, support staff, distributor fees, etc.

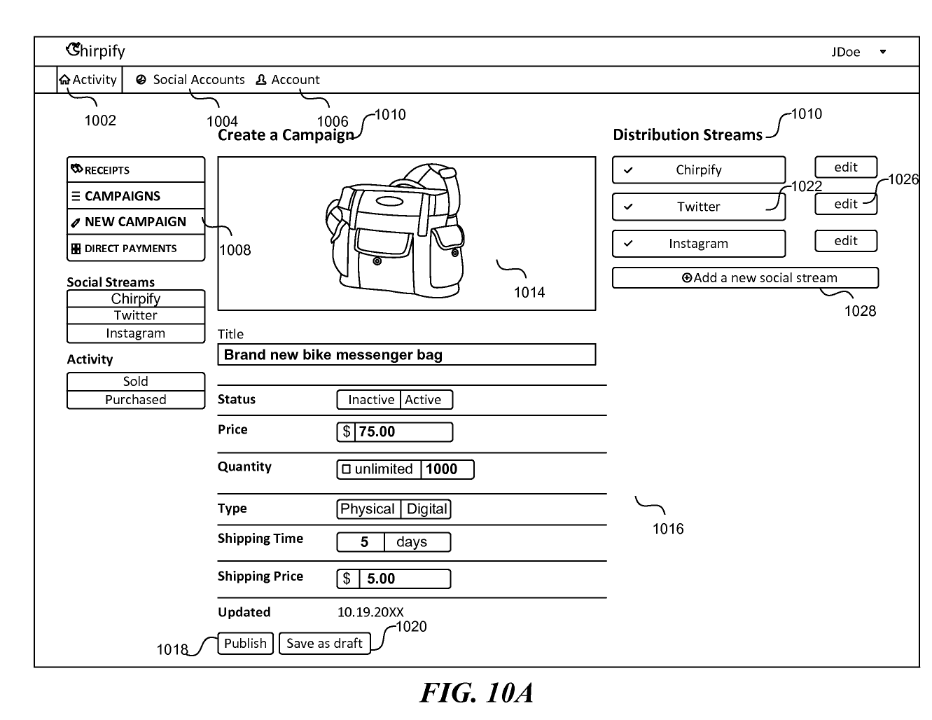

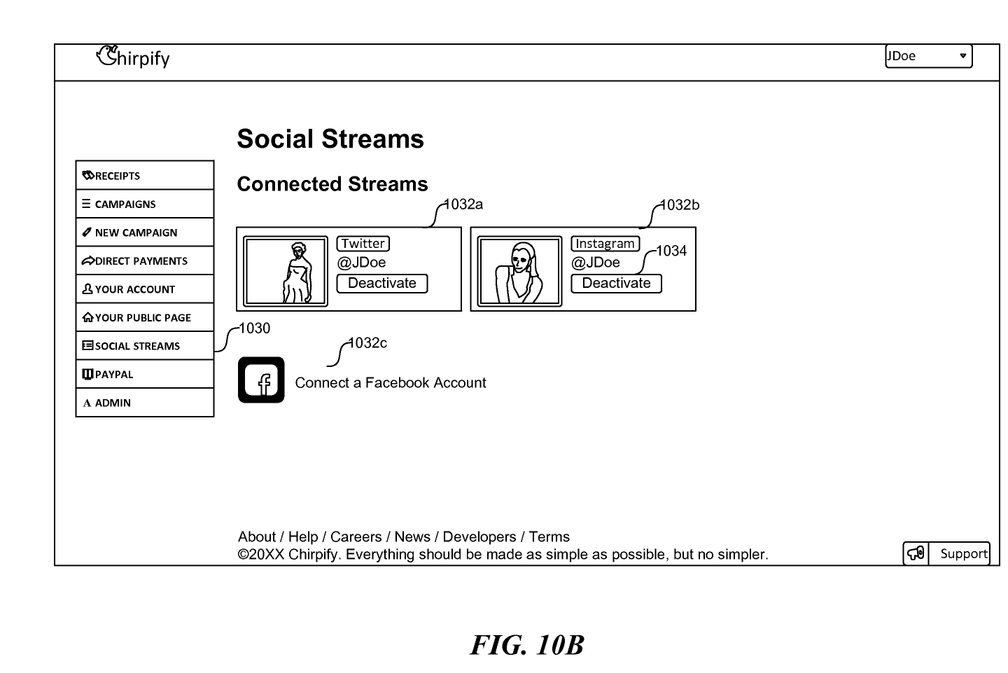

The campaign manager 416 receives the new campaign request 452 from a user to create a new campaign. The request may be initiated from a social network (e.g., INSTAGRAM) through the use of certain action tags (e.g., #instasale, #instagimme for INSTAGRAM). Alternately, the request may be initiated from the dashboard on the system website. FIG. 10A illustrates the creation of a new campaign from the dashboard. The campaign manager 416 captures and parses data in the request and processes the parsed data to generate a new campaign and one or more listings associated with the campaign for publication through one or more media channels on behalf of the user.

The request 452 may include a comment, a post, a caption, a picture, a video, a message, purpose or other description of the campaign along with selection of commands or keywords in the form of an action tag and a campaign tag. In some instances, only a single action tag may be sufficient for a campaign. In some instances, multiple action tags may be associated with a campaign. An example listing for the campaign can include a comment “Love the new song? Get it instantly.” The user may then select or specify a campaign tag “#bandname” and select an action tag of “#buy” that is associated with the campaign. The action tags that are associated with a campaign may be selected from a list of system-defined action tags via the action/campaign tag manager 426. In one embodiment, the request 452 may also include information such as price of the item(s) being sold, inventory size, shipping options, shipping price, type of item being sold, status (e.g., active or inactive), campaign start date and end date, conditions for starting/ending the campaign, and/or the like. Some of these information may be included at the time of the request 452 or may be added later on. Depending on the type of campaign, more or less information may be included in the request 452.

By allowing multiple action tags to be associated with a campaign, the system allows a user to select different actions for that campaign. For example, a user may want to have a campaign that provides consumers with an opportunity to purchase a product by the use of the action tag “#buy,” to receive more information about a product by the use of the action tag “#info,” or to express an indication that they like a product by the use of the action tag “#vote.” By allowing the user to specify which actions are available in a campaign, the user is provided with a greater ability to design campaigns that are suitable for the product, service, event, engagement or other opportunity that is being offered.

The campaign creator 418 uses the user provided information to create the requested campaign and generate a listing in the form of a message (e.g., post, comment, tweet) for distribution. For example, the generated comment for the listing may be substantially similar to “Love the new song? Get it instantly. Reply “#buy #bandname” for $1.29.” In this example, the portion “Reply “#buy #bandname” for $1.29” is auto-generated using the user-specified price, action tag and campaign tag. Alternately, the user can also use his or her own description in the post or edit the generated post (e.g., “Reply #buy #bandname to get our new song for $1.29”).

The action tag that is selected may identify a category of campaign (and by extension a listing under the campaign), such as: commerce, fundraising, payments, or other campaigns (e.g., voting campaign, donation campaign, sweepstakes). Alternately, the category of campaign may be determined from the comment. For example, the comment “Reply “#buy #bandname” to get our new song for $1.29” includes “#buy” as an action tag that is associated with a commerce campaign. Thus any comment with the “#buy” action tag is related to a commerce campaign. Similarly, commercial campaigns with no pay component are associated with other action tags such as “#gimme.” Fundraising campaigns are associated with action tags such as “#donate” or “#fund.” Payment campaigns, which may be a one time or recurring person to person payment, bill payment, etc., are associated with action tags such as “#pay.” Other campaigns may include action tags such as “#redeem,” “#subscribe,” (to sign up to receive periodic content) “#vote,” “#enter,” (to enter a contest or sweepstakes, “#info” (to receive additional information), #want (to pre-order a product) or the like, each action tag invoking a defined action or type of transaction. The disclosed action tags are merely examples of available action tags, and it will be appreciated that a greater or lesser number of action tags may be made available by the system for use in campaigns.

While action tags are typically depicted herein with a leading pound (#) sign, it will be appreciated that an action tag may be distinguished with any unique character, such as a dollar sign ($), ampersand (&), etc. As will be described in additional detail herein, the use of a unique character in the action tag may facilitate detection of the action tag by the system when monitoring social media and micro-blogs. Moreover, the unique character also acts as a reminder to a consumer when entering the action tag that an action will be triggered as a result of using the action tag. Such a reminder may reduce the number of consumer entries that trigger false actions by the system.

In contrast to system-defined action tags, campaign tags that are selected by a user are typically unique to a campaign, brand, company, organization, effort, or the like. For example, in the comment “Reply “#buy #bandname” to get our new song for $1.29” the “#bandname” is a campaign tag that is associated with a band that is offering the new song for sale. Campaign tags are defined by the user creating the new campaign, and can be any combination of characters and/or numbers. For example, a user can create and activate a campaign tag “#JDoeforSenate” for a campaign. Campaign tags may be managed via the action/campaign tag manager 426. For example, a user can use the same campaign tag for multiple campaigns (e.g., #bandname for all campaign activities relating to the band) or use a campaign tag that is unique to each campaign (e.g., #bandname_albumname as a campaign tag for a campaign to sell a specific album of the band). Campaign tags that are a brand name of a corporate, individual, or government (e.g., #adidas, #T-Mobile) typically persist for a long time (brand names are usually Trademarks). In contrast, other campaign tags may be quickly retired after the conclusion of a particular promotion but may be brought back into use (i.e., activated) at any time. In some embodiments, however, the system allows users to reserve the right to use certain campaign tags for a limited or unlimited time period. This would preclude other users from using the same campaign tags in their campaigns. The action/campaign tag manager 426 may track and manage availability of campaign tags for new campaigns.

While campaign tags are typically depicted herein with a leading pound (#) sign, it will be appreciated that a campaign tag may be distinguished with any unique character, such as a dollar sign ($), ampersand (&), etc. As will be described in additional detail herein, the use of a unique character in the campaign tag may facilitate detection of the campaign tag by the system when monitoring social media and micro-blogs.

The campaign data capture module 422 parses a request to create a new campaign in order to capture the data contained in the request and generate one or more listings. In one embodiment, the request may be associated with digital media content (e.g., e-book, song, music album, image, video). For example, the request can be a campaign to sell an .mp4 track. The media upload manager 424 can upload the digital media content file to a datastore (e.g., via a background process), while the user inputs other information related to the new campaign. When the upload is successfully completed, the media upload manager 424 displays a notification to the user.

The listing generated by the campaign creator 418 based on the information captured from the request may exist in various forms. For example, the new listing may exist as a draft, which is not published and remains private. Alternately, the listing may be published by the listing publisher 420. The listing publisher 420 receives from the user a selection of one or more social networks through which the new listing is to be distributed or published. If no social network is selected but the user requests publication of the newly created listing, a default setting may apply. For example, by default, the newly created listing may be published via all social networks that the user's account is linked to. The listing publisher 420 publishes the new listing in the selected social networks on behalf of the user. For example, if the newly created listing is to be published in TWITTER, the listing publisher 420 can use the TWITTER API, along with the access token provided by TWITTER during the OAuth process to publish the listing through the user's account in TWITTER.

In some embodiments, the system provides the user an option to distribute the listing through non-interactive media channels such as radio, print, broadcast, etc. Consumers listening to radio, reading the print, or watching the broadcast can identify the action and campaign tags associated with the listing and comment using the action and campaign tags from his or her social network account to engage in a transaction. Of course, users of the system may also independently elect to publish action tags and defined campaign tags in traditional media, such as a magazines, billboards, television, etc. In this fashion, consumers that view traditional media are made aware of the relevant action tags and campaign tags and can quickly take action by re-use of the viewed action tags and campaign tags in social media or other micro-blogging services. One example of such use would be campaign tie-ins for television programs such as American Idol. The campaign may be configured to start at a scheduled time and run for a specified duration. Audiences watching the program can use toll-free numbers (or other identifiers) assigned to contestants in the program to send their votes directly from social networks and micro-blogs. Comments on social networks and micro-blogs such as “#vote #5646 Love Kelly” along with traditional SMS text can then be used to collect votes from audiences. At the end of the voting period, the system tallies the votes for contestants captured from the comments and provides results to the campaign organizer.

In one embodiment, the action page manager 428 creates and manages landing pages or action pages for campaigns. The landing pages may be hosted by the web server 302. The landing pages are configurable by users to provide information regarding the corresponding listings and include buttons or other widgets using which consumers can engage in transaction.

As noted above, the system 400 is integrated with one or more social networks in order to detect and take action on action and campaign tags that are used by users. The user content monitor 430 monitors content such as comments, posts, responses, tweets, messages, and/or the like in the social networks. For example, the content monitor 430 uses APIs exposed by the social networks to connect to the social networks and access real time content (e.g., TWITTER APIs, FACEBOOK APIs, INSTAGRAM APIs). For example, the content monitor 430 can use the streaming APIs provided by social media channels to access public streams (e.g., public data flowing through TWITTER), user streams (i.e., data relating to a user) and/or site streams (i.e., data relating to multiple users). In one embodiment, the content capture module 432 captures content relating to all users of the system (i.e., registered users or members). For example, a post by a user and/or responses to the post by any other unregistered or registered users can be monitored. Alternately, in another embodiment, the content capture module 432 captures content relating to both members and non-members alike.

The content parser 436 parses the captured content to determine if the captured content is an in-stream transaction. The content parser 436 identifies a captured content as an in-stream transaction by parsing the content to determine if it includes an action tag (i.e., command) and a campaign tag (i.e., a keyword or other campaign identifier). In one embodiment, the content parser utilizes natural language processing to parse comments or posts. The natural language processing ensures that there are no false negatives in recognizing specific keywords or phrases included in comments or posts to complete a transaction.

In TWITTER, the action and campaign tags usually begin with the “#” symbol (#vote for #JoeforSenate). However, action and campaign tags may also begin with other symbols or tags (e.g., /vote for /JoeforSenate, *vote for *JoeforSenate). Users may even use trailing symbols or characters with action tags and/or campaign tags (e.g., buy! or buy!!!). The content parser 436 compares the parsed data to a list of active (or all) action tags and campaign tags (e.g., managed by the action/campaign tag manager 426) to determine whether the captured content is an in-stream transaction.

In addition to determining if the captured content includes an action tag and a campaign tag, the content parser 436 may also parse the content to extract additional information. For example, the content parser 436 may parse an example tweet “#vote for #JoeforSenate” to extract the “vote” action tag and “JoeforSenate” campaign tag and the username of the user who sent the tweet (e.g., TWITTER username). By way of another example, the content parser 436 can parse a tweet “Pay! @Joe for coffee $4.50 #Chirpify” to extract the action tag “pay,” the payee “Joe” (i.e., TWITTER username), the payer (TWITTER username), the amount “$4.50” and the reason “for coffee.”

In one embodiment, the content filter module 434 filters out or discards any content that does not include an action tag and a campaign tag that are currently active and forwards the content identified as an active in-stream transaction to the transaction processor 438 for further processing. Alternately, the content filer module 434 may select content that includes an action tag and a campaign tag that are currently active or were previously active. The content filter module 434 then classifies the selected content into an active campaign group and inactive campaign group so that the content in each group can be processed appropriately. In one embodiment, the function of the content filter module 434 may be performed by the content parser 436.

The transaction processor 438 processes active in-stream transactions. In one embodiment, the transaction processor 438 determines if the user initiating the in-stream transaction is a member and has a payment account associated with the account. If so, the transaction processor 438 process the in-stream transactions according to parameters associated with the in-stream transaction (e.g., the details extracted by the content parser 436). For example, for the in-stream transaction “#Pay @Joe for coffee $4.50 #Chirpify” with the action tag “pay,” the transaction processor 438 debits $4.50 to the payee's financial account and credits the payer's financial account with at least $4.50. Additional transaction fee may apply. Similarly, an in-stream purchase transaction characterized by the action tag “buy” and involving a credit card, can trigger the transaction processor 438 to send a payment authorization request 458 to a payment processor/gateway. The payment processor obtains the necessary authorization and responds with an authorization response 460. If the authorization response is an approval, the transaction processor 438 completes the transaction. If the authorization response is decline, the transaction processor 438 sends a notification to the user regarding the failed transaction.

In the example in-stream transaction “#Pay @Joe for coffee $4.50 #Chirpify,” if the user “Joe” is not a member, then the transaction cannot be processed. The transaction processor 438 uses the notification module 440 to send a notification to the user Joe to sign up to receive the payment. The unprocessed transaction handler 444 tracks and saves the unprocessed transaction (or pending transaction) until the user Joe signs up and provides a financial account where the fund can be deposited.

The notification module 440 generates and sends notification upon successful processing of an in-stream transaction. The notification module 440 generates and sends a successful transaction notification to the user initiating the transaction (e.g., payer, buyer, contributor or transaction requester). The notification module 440 generates and sends a successful transaction notification to the user associated with the listing (e.g., seller, campaign creator), payee, or the like. In one embodiment, the notification module 440 also sends receipts generated by the receipt manager 442 to transaction participants following successful conclusion of transactions. The receipts manager 442 further aggregates, tracks and organizes receipts of past transactions on the user's dashboard.

The user interface module 448 generates graphical user interfaces with which users can interact to provide campaign information to create and modify campaigns, create and modify listings associated with the campaigns (e.g., FACEBOOK listing, TWITTER listing), view receipts, and the like. The user interface module 448 also includes display and configurations tools that users can use to configure or organize their dashboards, landing pages, or the like.

The modules described with respect to the in-stream transaction processing system 400 have been described in the general context of the system. These modules may reside on one or more servers or user devices. For example, the modules may be distributed over the web server 302, the API server 304, the APP server 306 and/or the user devices 324a-d.

FIG. 4B is an example structure 480 of a database coupled to the in-stream transaction processing system. The users table 482 and the users_profile table 484 store user data such as name, address, shipping preferences, billing preferences, clothing size, and the like. The users table has fields of information such as, but not limited to: ID (i.e., the primary key), a username (i.e., foreign key), financial account information (e.g., paypal_token), or the like. The users_profile table 484 has fields of information such as, but not limited to: ID, username, address, clothing size, and/or the like. The social_identities table 492 stores information for each social network linked to the user, and includes various fields of information such as, but not limited to: ID, user_ID (i.e., social network ID), handle, avatar, platform (i.e., social network), or the like. The campaigns table 488 stores data relating to campaigns and corresponding listings, including commercial, direct pay, fundraising, and/or other campaigns. For example, the campaigns table 488 may store product information, for both digital and physical sale items, meta data about items for sale (e.g., distribution channel, inventory amounts, price, shipping cost, and the like), etc. The campaigns table 488 may include various fields of information, such as but not limited to: ID, user_id, price, quantity, indication whether the item is_digital, status (e.g., active, inactive) and/or the like. Once the transactions have occurred, records on the transaction are entered into the purchases or transactions table 486. The purchases/transaction table 486 may include various fields of information, such as but not limited to: ID, campaign_id, payer_id, payee_id, date/time, price/amount, or the like. Unsuccessful transactions (e.g., transactions made by non-members or transactions with failed authorization) may be stored in the unprocessed_transactions table 490 to be processed at a later time. The unprocessed_transactions table 490 may include various fields of information such as, but not limited to: ID, campaign_ID, post_ID, handle, platform, or the like.

### 4. EXAMPLE PROCESSING

FIG. 5 is a block diagram illustrating an example method 500 for creating a user account with the in-stream transaction processing system. At block 505, a user accesses the system website and requests creation of a user account by providing information such as username, email, password, phone number, or the like. Alternately, the user can sign up via a third-party service (e.g., TWITTER, INSTAGRAM, FACEBOOK) utilizing the OAuth or other similar protocol. After creating a user account, the user can request the system to link the user account with one or more social network accounts such as micro-blogs (e.g., TWITTER, TUMBLR), photo/video or other media sharing platforms or services (e.g., INSTAGRAM, YOUTUBE, VIMEO, PINTEREST), social media networks (e.g., FACEBOOK, GOOGLE+). The user account is linked to the specified social networks (or social streams) via OAuth or other protocol for authentication supported by the social networks. Establishing and linking the user account to a social network account allows the user to engage in a subset of transactions that do not have a payment component, directly from the social network platform. For example, the user can comment using an action tag “gimme” and a campaign tag (e.g., “#freesong”) in response to a payless (or nopay) listing for electronic download. Since the “gimme” action tag is associated with a payless listing or giveaway, the user's comment including the “gimme” action tag along with the campaign tag can trigger an in-stream payless transaction. The system processes the transaction in real time or near real time by sending the user a link to download the free content. Similarly, the user can also participate in campaigns such as voting campaigns, sweep stakes campaigns, or the like that do not involve payment.

At block 520, the user requests the system to link his or her account to one or more financial accounts (e.g., a bank account, a PAYPAL account, credit/debit/prepaid card). Once the user account is linked to a financial account, the user can engage in in-stream transaction involving pay component at block 530. For example, the user can send a tweet from his or her linked TWITTER account to buy an item, pay another user or bill pay, contribute to fundraisers, etc., which involve payment. The user can also create listings to sell, giveaway, fundraise, pay, or the like through one or more social media channels at block 525. At block 535, the user provides additional information such as shipping address, purchase preferences (e.g., shoe size, dress size, t-shirt size), or the like for the user profile. Providing the additional information qualifies the user to engage in in-stream transactions involving delivery of physical goods at block 540. In some instances, it is possible for the user to engage in in-stream transactions involving physical goods without providing shipping or purchase preference, as long as the user provides the required information when prompted by the system.

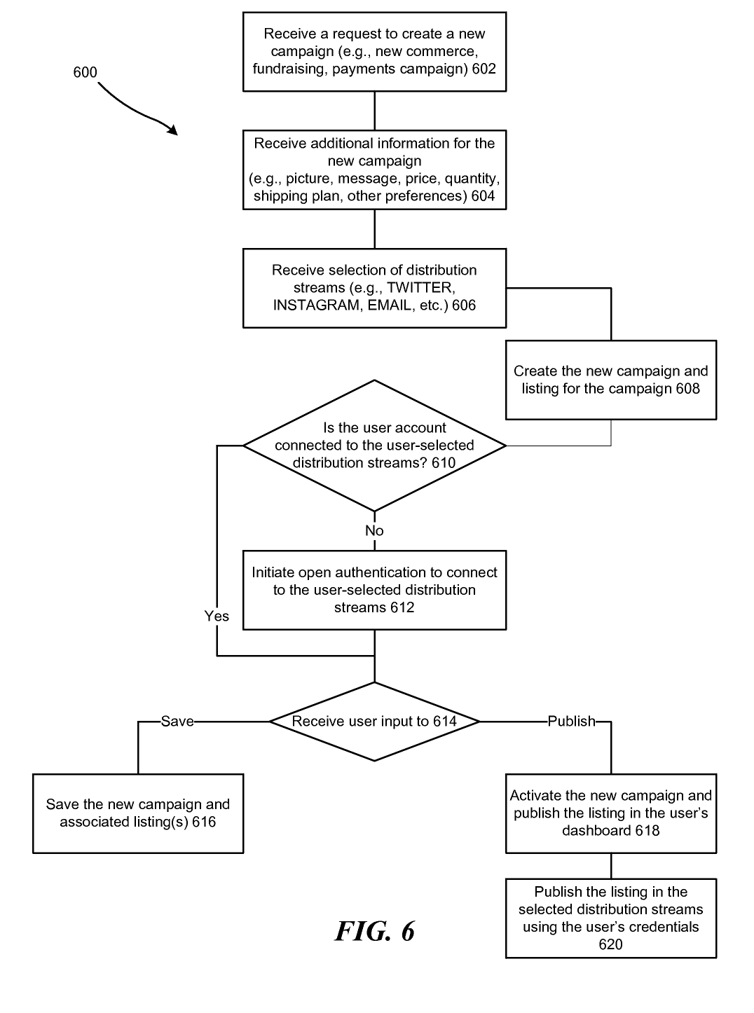

FIG. 6 is a logic flow diagram illustrating an example method 600 for creating a campaign and publishing a listing associated with the campaign on a system website or in one or more social networks. At block 602, the in-stream transaction processing system receives a request to create a new campaign. The request may originate from a third-party service application (e.g., from INSTAGRAM) or the user may login to the system website and utilize the user dashboard to submit the request. The request may include information such as a media file (e.g., photo in a photo-sharing service application, a video in a video sharing application), a caption or text that comprises an action tag, a campaign tag, or an action tag and a campaign tag, price, and/or the like. The information in the request can depend on the type of campaign being created. For example, if the campaign is related to a sale, the caption or text includes an action tag associated with commercial activity and price. The request may also be related to fundraising, direct payment or other campaigns, some of which may not involve a payment component (e.g., campaigns to giveaway an item for free).

At block 604, the system receives additional information relating to the campaign. For example, additional information may include campaign meta data such as, but are not limited to: quantity, shipping plan, shipping price, quantity or other options. The additional information may also include campaign configuration parameters such as start/end date. The user utilizes the dashboard to provide the additional information to the system. In some embodiments, the additional information may not be needed or may be provided at block 602, in which case, block 604 may be optional. At block 606, the system receives a selection of one or more distribution streams through which a listing associated with the new campaign is to be distributed. The user can select or add new distribution streams. For example, the user can select social networks such as FACEBOOK, TWITTER, INSTAGRAM, etc. In some embodiments, the user may also select other distribution channels such as email, short message service (SMS), multimedia message service (MMS), online, print or broadcast advertisement, or the like. Although distribution of the listing may occur through non-user interactive channel such as print or broadcast, the system supports and processes in-stream transactions through comments, posts, messages, tweets, or other interactive activity on user-interactive media channels such as social networks that are connected or linked to the user account. In one embodiment, the system allows the user to customize the listing for each distribution stream.

At block 608, the system creates the new campaign according to the information received in the request and/or additional information (which may be supplied later on) and a listing for each selected distribution stream. When the new campaign is created, the new campaign is associated with a campaign ID, and stored in the campaign table 488. Different listings for the same campaign (i.e., listing with 140 characters for TWITTER and listing with a picture for INSTAGRAM) may exist depending on user customization for different distribution streams. At decision block 610, the system determines if the user account is linked to the user-selected distribution streams (or if the access token is still valid). If the user account is not linked to the user-selected distribution streams or if the access token is invalid or expired or needs to be refreshed, the system redirects the user to each of the distribution streams to allow the distribution streams to authenticate the user and obtain access tokens at block 612.

Once the user account is confirmed to be connected to the user-selected distribution streams, the user may instruct the system to save the new campaign or activate the campaign by publishing the listing for the campaign. At decision block 614, if the system receives a user input to save the new campaign, the system saves the new campaign and the associated listing at block 616, without publishing it. Alternately, if the system receives a user input to activate the new campaign at block 614, the system activates the new campaign by publishing the listing associated with the campaign in the user's dashboard at block 618 and all selected distribution streams at block 620. For example, if the listing is to be distributed through TWITTER, the system uses the user's TWITTER account credentials (i.e., access token) to send the new listing as a tweet. Since the tweet is sent using the user's TWITTER account credentials as authorized by the user, the tweet appears to be from the user and can be seen by the user's TWITTER followers.

The system may also receive a request to update or modify an existing campaign or a published or unpublished listing. The request may include changes to the campaign information such as quantity, price, message, shipping options, distribution stream modifications, etc. In response, the system updates the campaign or listing associated with the request. The updated campaign or listing information is then accessible to the user via the user's dashboard. The outdated listing may be deleted from the user's social media accounts and the updated listing may be published through the social media accounts. The system may even track or manage various versions of campaigns or listings, so that the user can easily switch to a previous version of a campaign or listing when desired, directly from the dashboard.

In another embodiment, the system receives as additional information (e.g., at block 604) such as one or more criteria for publication of a new listing. When the one or more criteria is met, the system executes the publication of the listing automatically. For example, the user can setup the campaign to go live on a certain date or to coincide with an event. Similarly, the system may also receive one or more criteria for deleting or inactivating a campaign, after which the system stops processing the in-stream transactions associated with a listing for the deleted or inactivated campaign. For example, the user can setup the campaign to expire after a period of time or after the inventory runs out. In one embodiment, the system automatically deletes or clears comments, posts, etc., relating to a campaign once the inventory runs out. The user can even suspend a campaign on demand, or schedule campaigns to go live (i.e., be published) according to a schedule, all from the dashboard.

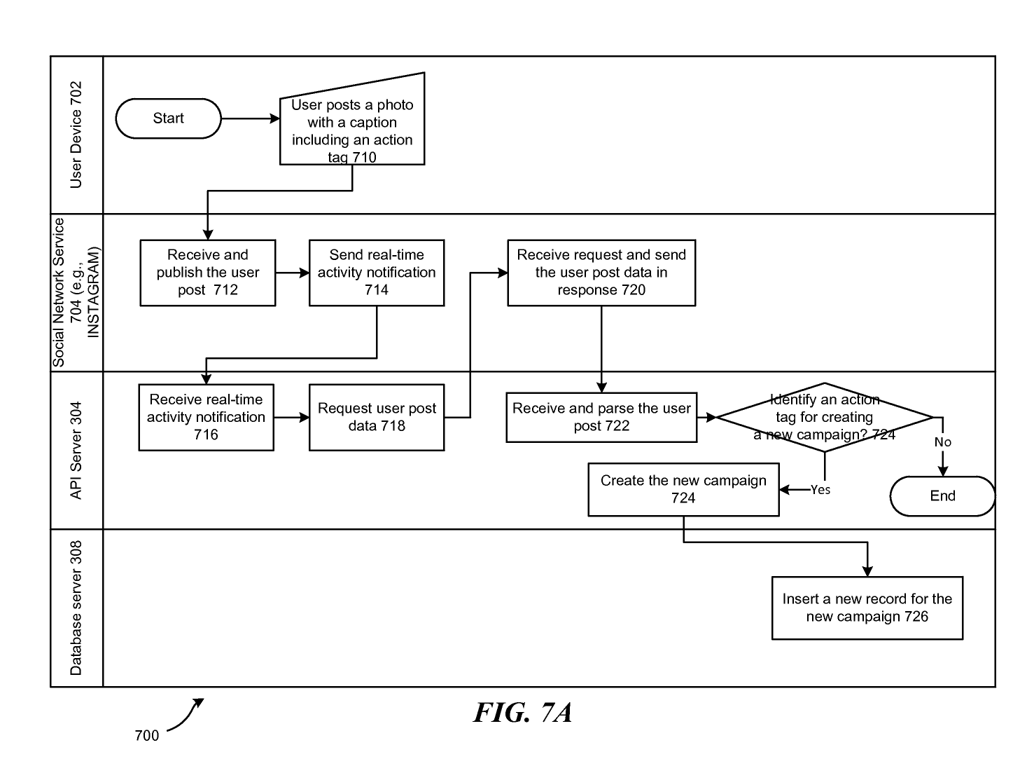

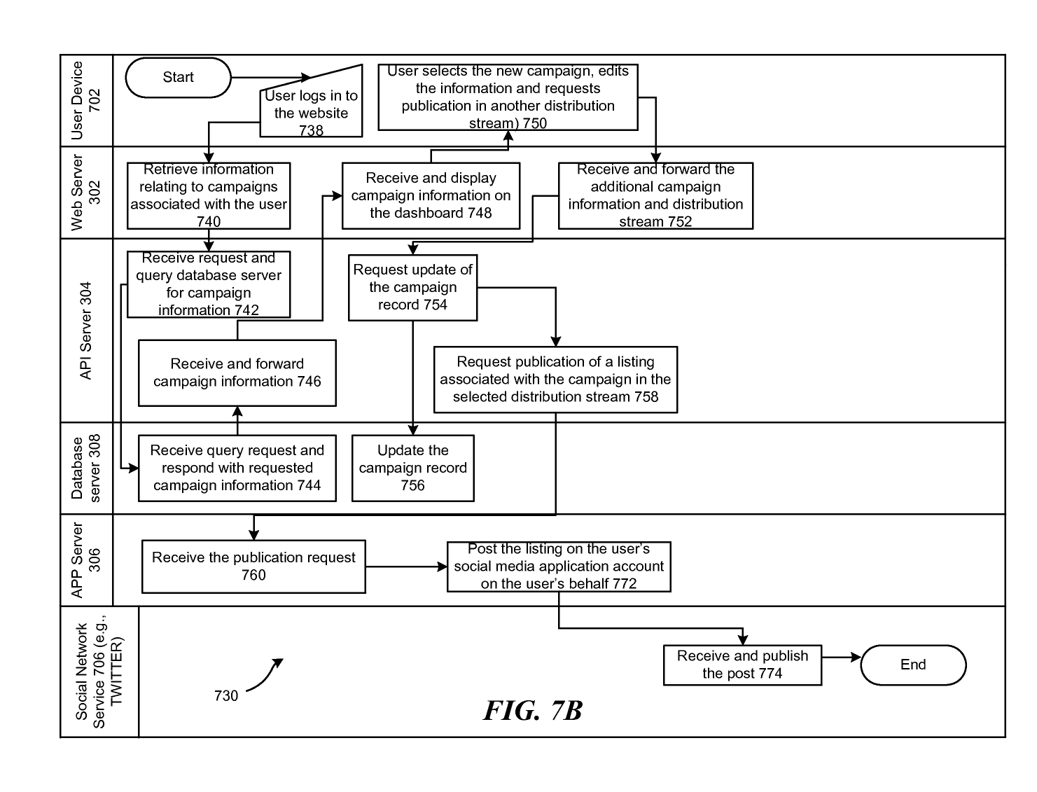

FIGS. 7A-7B are functional diagrams that illustrate the functions of the server components of the in-stream transaction processing system in creating a campaign, publishing a listing associated with the campaign and processing in-stream transactions. Referring to FIG. 7A, the functional diagram 700 shows the flow of data among a user device 702, a social network service (e.g., INSTAGRAM) 704, the API server 304 and a database server 308 in the process of creating a campaign from the social network service application 704 for distribution through one or more social network service applications.

A user using his or her user device 702 launches a photo-sharing application to post a photo along with a caption that includes an action tag and a campaign tag, product information, price, or the like at block 710. The user post data (i.e., image file and caption) 708 is uploaded to the social network service application server 704, which publishes the photo and the caption on its site at block 712. In one embodiment, the social network service application server 704 sends a real time user activity notification 714 to the API server 304. The API server 304 receives the user post data at block 716 and fetches the user post data via an API call 718 (supported by the social network service application server 704) to the social network service application server 704 (or a suitable API endpoint). Alternately, the API server 304 may be configured to poll the social network service application server 704 for updates to the user's social network account. The social network service application server 704 receives the API request and sends the requested user post data in response at block 720.

The API server 304 receives and parses the user post data at block 722 to determine whether the user post data corresponds to a request to create a new listing. The API server 304 examines the parsed data to identify an action tag for creating a campaign, which can be specific to the social network service application server 704 (e.g., “instasale,” “instagimme” or “instafund” for INSTAGRAM). If the user post is for creating a new campaign, the API server 304 creates a new campaign based on the user post data at block 724. The API server can, for example, generate a query request (e.g., INSERT statement in SQL) to the database server 308 to request the database server to create a new campaign record on the listings table 488. The database server 308 receives the query request and creates a new campaign record having a campaign ID in the campaigns table 488 at block 726. If the user post is determines to be unrelated to creation of a new campaign, the API server 304 does not process the user post data further.

Referring to FIG. 7B, flow of data between the user device 702, the web server 302, the API server 304, the database server 308, the APP server 306 and another social network service application server (e.g., TWITTER) 706 is illustrated. At block 738, the user logs in to the system website. The web server 302 initiates authentication of the user (via OAuth protocol) and retrieves information relating to the user at block 740 by making one or more API calls to the API server 304. The API server 304 in turn queries the database server for information relating to the user (e.g., campaign information, receipts, etc.) at block 742. The database server 308 receives the query from the API server 304 and returns a response at block 744 to the API server 304. The API server 304 receives the response and forwards the response to the web server 302 at block 746. The web server receives the response and displays the response in the dashboard at block 748. After all the pertinent data is displayed on the dashboard, the user uses the user device 702 to select the new campaign (from FIG. 7A) and add additional information (e.g., inventory quantity, shipping options) to the campaign at block 750. The user also selects a social network service 706 and customizes a listing for the social network service 706. The web server 302 receives the updated campaign information and forwards the updated campaign information to the API server 304 at block 752 to request the API server 304 to publish the listing. The API server 304 receives the updated campaign information and generates a query to the database server 308 to update the campaign record stored on the campaigns table 488 at block 754. The database server 308 receives the update query request and updates the campaign record at block 756.

In one embodiment, the API server 304 sends the listing information for the social network service 706 to the APP server 306 for publication at block 758. The APP server 306 receives the publication request at block 760. The APP server retrieves an access token (or obtains an access token if the previously obtained access token needs to be refreshed) associated with the user issued by the social network service 706 (e.g., via the API server 304). The APP server 306 then uses the access token to publish the listing as a post on the social network service 706 on the user's behalf at block 772. The social network service application server 706 receives and publishes the post at block 774.

Once a listing is published in one or more social networks, the in-stream transaction processing system allows users (members and non-members alike) to engage in transactions directly from their social network accounts, simply by using action tags and campaign tags in a comment, message, post, tweet or the like. Since the comments, messages, posts, tweets or the like are activities performed by users on social media platforms, the system monitors registered users' activities on other social media platforms to detect and complete in-stream transactions in real time or near real time. It should be noted that some of the in-stream transactions may occur on the system website itself (e.g., dashboard, landing page) and the system monitors activity on the system website to identify and complete transactions.

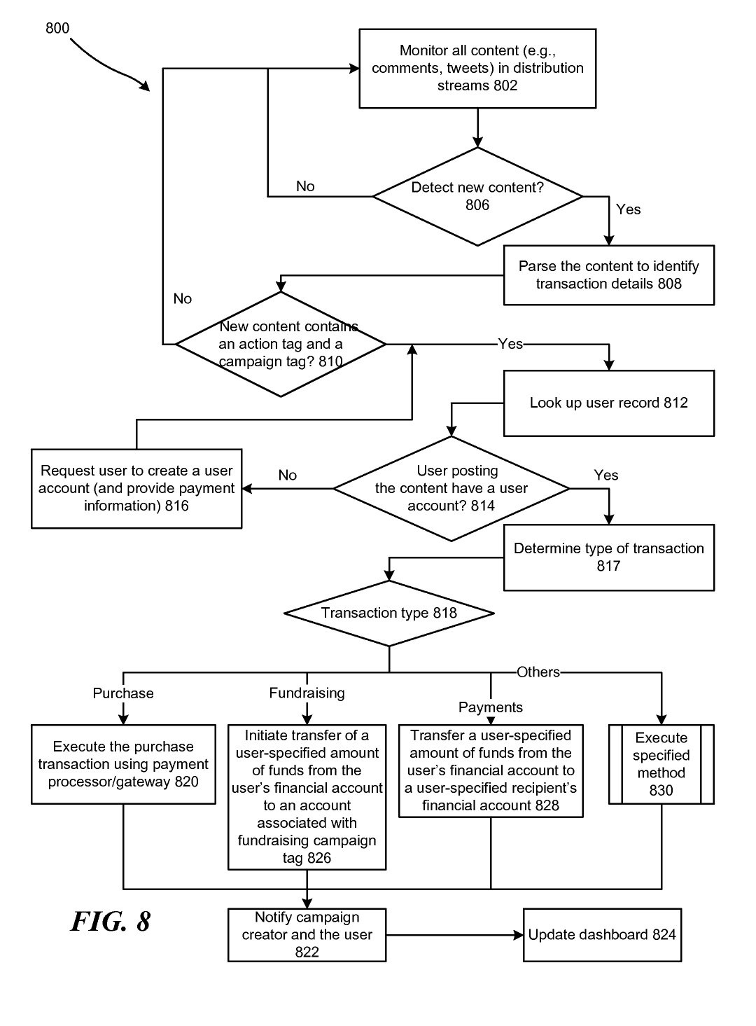

FIG. 8 is a logic flow diagram illustrating an example method 800 for identifying and processing an in-stream transaction by the in-stream transaction processing system. In one embodiment, the system monitors all content (e.g., comments, tweets, posts, uploads, messages or other activities) in distribution streams including social networks (and wherever the in-stream transaction is supported) for activated action tags and campaign tags at block 802. Alternately, the system may monitor all content published by members (i.e., registered users) in distribution streams for activated action tags and campaign tags at block 804. At decision block 806, if the system detects no new content, the system continues to monitor the distribution streams for new content. Alternately, if the system detects new content, the system captures and parses the new content in the distribution streams to identify transaction details at block 808. Transaction details may include an action tag and a campaign tag, price, payor name, payee name, an amount, price or the like. At decision block 810, if the system detects an action tag and a campaign tag in the new content, the system identifies the new content as an in-stream transaction. The system then looks up the user record of the content creator (e.g., user who posted the comment) at block 812. If the user has no user record, the user is not a member. The system then requests the user to create a user account (and provide financial account details if necessary) to complete the transaction at block 816. Alternately, if the user is a member, the system determines a type of in-stream transaction to be processed at block 817 and processes the transaction accordingly.

At decision block 818, if the transaction is a purchase transaction, the system executes the purchase transaction at block 820 via the payment gateway/processor. For example, the system obtains payment authorization for the user's financial account via the payment gateway or processor. The system then notifies the seller and the user (i.e., buyer) regarding completion of the transaction at block 822. The transaction details are populated in the buyer's and seller's dashboards at block 824 so that the buyer a can access the receipts on his or her dashboard and the seller can deliver any physical goods. If the goods are digital content (e.g., songs, albums, movies, e-books), the system or the seller may manage the delivery of the digital content.

Similarly, if the transaction is a fundraising type of transaction, the system initiates a transfer of a user-specified amount of funds from the user's financial account to a financial account of a user associated with the fundraising campaign at block 826. The system then notifies the user associated with the fundraising campaign and the contributor or payer regarding completion of the transaction at block 822. One transaction type is direct payment type. For such a transaction, the system transfers a user specified amount of funds extracted from the comment from the user's financial account to a user-specified recipient's financial account at block 828. Following successful completion of the transaction, the payor (i.e., the user posting the comment) and the payee (the user specified in the comment) are notified. Detailed receipts for the fundraising and direct payment transactions may be sent to the relevant parties directly through email, or other methods and may be accessed from the dashboard.

While purchase, fundraising and payment transactions involve a payment component, the system also processes transactions with no payment component. No pay transactions may be identified based on action tags such as gimme, instagimme, nopay, vote, subscriber, or the like. The system may then process such transactions by performing an associated method or action at block 830 For example, if the transaction is related to a request to subscribe to a free newsletter, the system captures the requesting user's information (e.g., email address) and aggregates the information regarding all subscribing users on the campaign creator's dashboard. The campaign creator can download or export the aggregated information to his or her own platform for distributing the free newsletter.

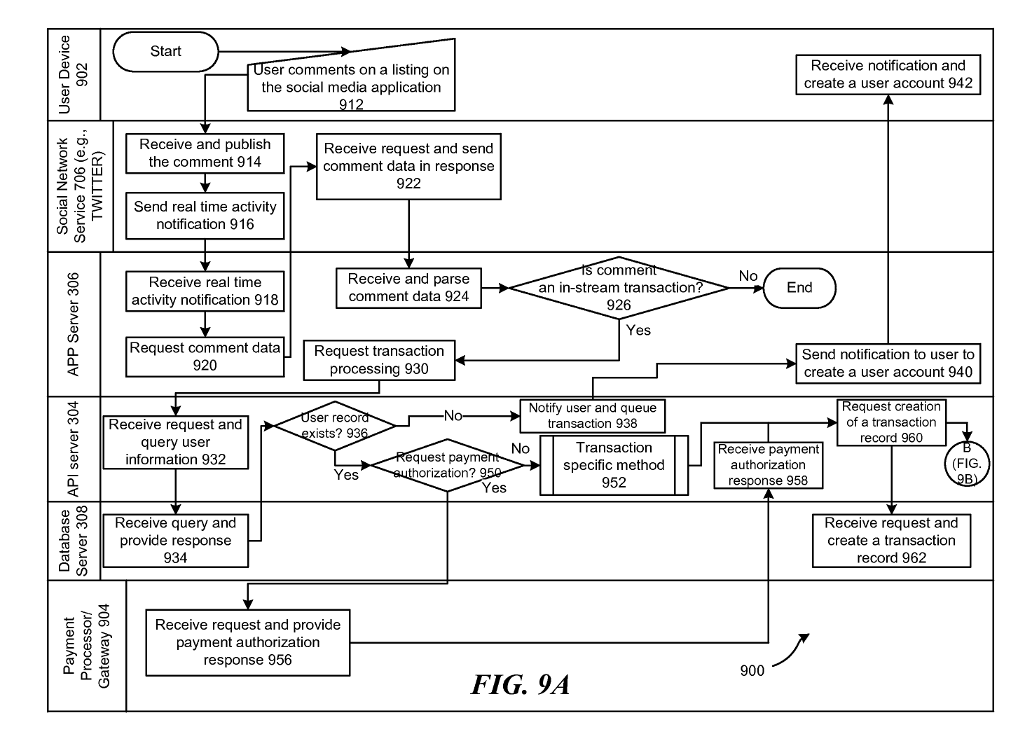

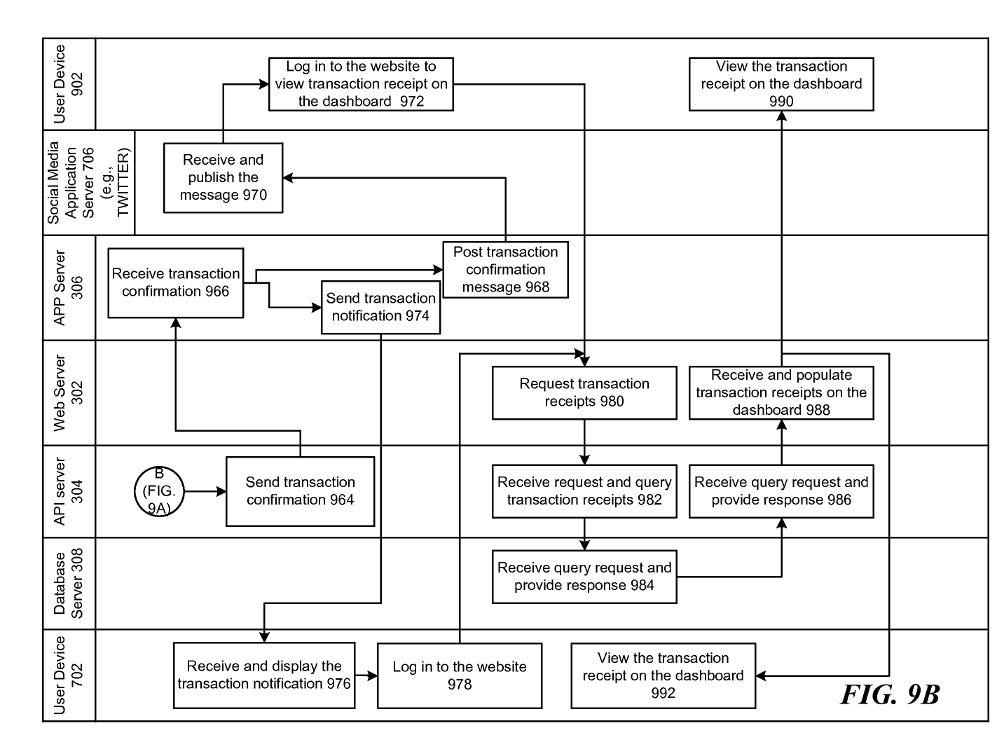

FIGS. 9A-9B are functional diagrams illustrating the flow of data among a user device 902, a social network service 706, the APP server 306, the API server 304, the database server 308, the payment processor/gateway 316 in the process of identifying and completing an in-stream transaction and notifying transaction participants upon completion of the transaction.

Referring to FIG. 9A, a user uses a user device 902 to access a social network service 706 application to comment on a listing on the social network service (e.g., TWITTER) at block 912. In one embodiment, the listing may have been listed elsewhere (e.g., listing may be advertised on print media). The user's comment includes an action tag and a campaign tag. The user's comment may also include other details depending on a specific campaign or type of campaign associated with the listing. The social network service 706 receives and publishes the comment at block 914. The social network service 706 also sends a real time activity notification to the APP server at block 916. The APP server 306 receives the real time activity notification at block 918 and fetches the activity data from the social network service using one or more API calls at block 920. The social network service 706 receives the request and sends the activity data to the APP server at block 922. Alternately, the social network service 706 may periodically or in real time or near real time fashion push new data to the APP server 306, such that there is no latency between the time of the comment and processing of the transaction triggered by the comment. The APP server 306 receives and parses the comment at block 924 to extract details of the comment to identify the comment as an in-stream transaction. At decision block 926, the APP server determines whether the comment is an in-stream transaction. If the comment includes an action tag and a campaign tag, the comment is determined to be an in-stream transaction. The APP server 306 then sends the transaction details to the API server 304 for processing at block 930. Alternately, the APP server 306 takes no further action.

The API server 304 receives the transaction details for processing at block 932. The transaction details may include information such as campaign ID, payer ID, payee ID, action tag, campaign tag or the like. The API server 304 queries the database server 308 for user information at block 932. The database server 308 receives the query request, executes the query request and provides a query response to the API server 304. If there is no user record as determined at decision block 936, the API server 304 notifies the user and queues the transaction for processing later on at block 938. The API server 304 may request the database server 308 to create a new record in the unprocessed_transactions table 490 to store the details of the transaction that cannot be processed immediately. The notification is received by the APP server 306, which sends a notification to the user to create a user account at block 940 (e.g., via the social network service 706). The user receives the notification on the user device at block 942 and may create a user account from the system website. When the user account is created, the system automatically resumes the transaction processing by retrieving the unprocessed transaction associated with the user from the unprocessed_transactions table 490.

Alternately, if the API server 304 identifies a user record, the API server 304 determines if a payment authorization is to be requested at decision block 950. If the transaction does not have a payment component, the API server 304 performs a transaction-specific method at block 952 (or requests the APP server to perform the transaction-specific method). For example, a subscription type transaction may be processed by including information relating to the user in a subscription or enrollment list that the campaign creator can view or export. Similarly, a voting type transaction may be processed by keeping a tally of votes received and providing the campaign creator the total. Alternately, if the transaction includes a payment component, the API server 304 requests the payment processor/gateway 904 (e.g., via API or other methods) for payment authorization based on the transaction. The payment processor/gateway 904 obtains payment authorization and sends an authorization response back to the API server 304 at block 956. When the API server 304 receives a payment authorization response approving the transaction at block 958, the API server 304 requests the database server 308 to create a transaction record at block 960. The database server 308, in response to the request, creates a transaction record in the purchases/transaction table 486 to store details of the completed transaction at block 962.

Referring to FIG. 9B, in one embodiment, the API server 304 further sends a transaction confirmation message 964 to the APP server 306. The APP server 306 receives the confirmation at block 966 and sends a transaction confirmation message 974 to the user device 702 (e.g., from FIG. 7A) and a transaction confirmation message 968 to the user's social network service 706 account. When the user of the user device 702 (or 902) logs in to the system website at block 978 (or block 972), the webserver 302 then initiates authentication of the user (e.g., via OAuth protocol). The web server 302 then retrieves transaction details and other information associated with the user account via the API server 304 (blocks 980-986) and populates the retrieved information on the user's dashboard. The user, using the user device 702 (or 902), accesses the dashboard to view the transaction receipt on the dashboard at block 992 (or block 972).

In one embodiment, in addition to the purchase through comments or posts on social networks, the in-stream transaction processing system also allows users to transact through a landing page or action page associated with a campaign. The landing page may be hosted by the web server 302. Users can visit the landing page and engage in transaction from thereon. For example, a user may click on a transaction button on the landing page of a campaign, which triggers the API server 304 to process the transaction.

### 5. EXAMPLE USER INTERFACES

A dashboard 1000 that is accessible to a user to create and manage new campaigns, manage distribution of the listings associated with campaigns, view transaction details, and the like is shown in FIG. 10A. The dashboard may include an activity tab 1002, a social accounts tab 1004 and an account tab 1006 as shown. Under the activity tab 1002, a user can view receipts and campaigns, create new campaigns or set up direct payments. When the new campaign option 1008 is selected, the “Create a Campaign” panel 1010 is displayed. The user can upload a picture 1014 (upload button not shown) and provide campaign information 1016 such as a title (or comment, caption or other text), status, price, quantity, type of item (physical or digital), shipping time, shipping price, last update date, or the like. After supplying the campaign information, the user can publish a listing for the campaign by selecting the publish button 1018 or select the save as draft button 1020. The user can also select distribution streams 1010. The listing that is created may be published on distribution stream 1022 (i.e., on the dashboard, on the landing page), TWITTER 1024, INSTAGRAM 1026, or other new social streams 1028 that the user can add. The user can also customize the listing for publication through 1022, 1024 or 1026 using the edit option. For example, for TWITTER 1024, the user can edit the listing title from 1016 to be “Brand new bike messenger bag $75.00 To get yours reply #buy #madeinusa” and publish the listing in TWITTER.

FIG. 10B shows a view of the dashboard displaying social streams connected to a user account. When the social streams option 1030 is selected, all social streams connected to the user account are displayed. In FIG. 10B, TWITTER 1032a and INSTAGRAM 1032b are displayed as being connected to the user account. The user can deactivate the social streams 1032a and 1032b at any time by selecting the deactivate button 1034a and 1034b respectively.

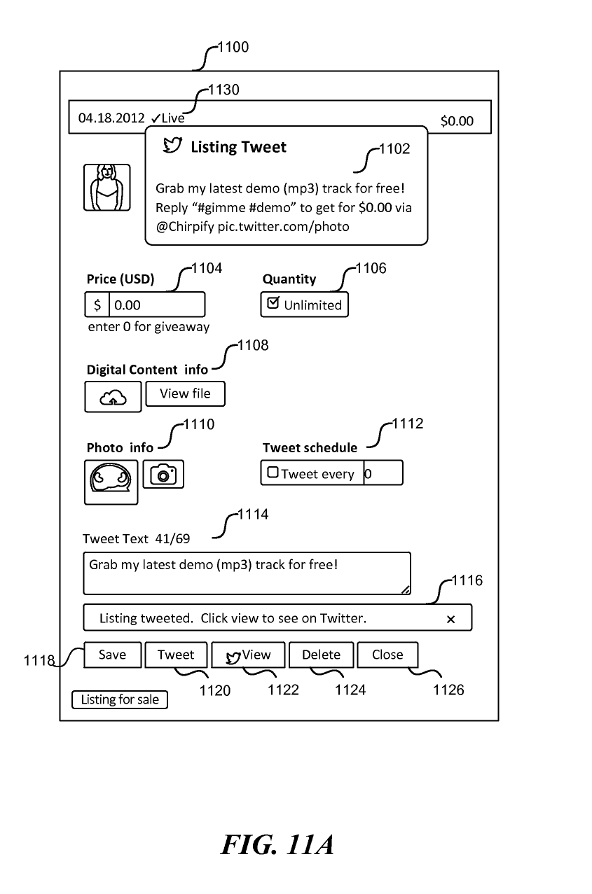

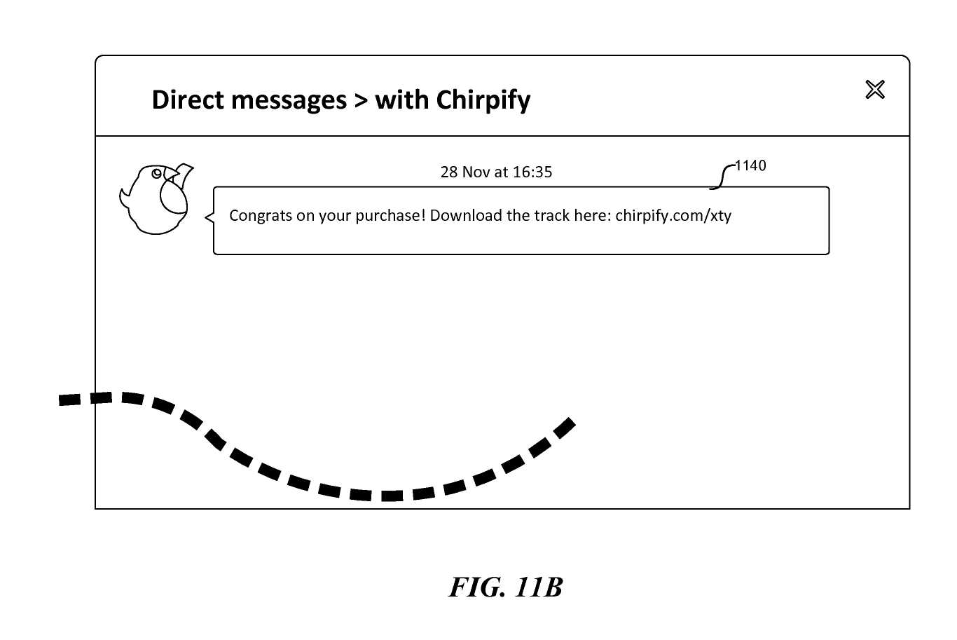

FIG. 11A shows a user interface 1100 for creating and publishing a listing of a digital content for free. A user launches an application (e.g., Android, iOS or other operating system based application) on his or her mobile device to create a new campaign to list an item for free. When the user interface 1100 is displayed, the user sets the price of the item being listed to $0.00 (or another amount if the item being listed is not free) and a quantity 1106 (unlimited or a finite number). The user then uploads the digital content to be listed using the view file/upload button 110. The user also has the option of uploading a photo using the icon or button 1110 and/or setting a tweeting schedule 1112 for the listing to be tweeted. The user then enters the text to be tweeted in the text box 1114. Since TWITTER has a limit of 140 characters in each tweet, the text box may only accept text of certain length (e.g., 69 characters in the example). The user can then select save 1118 to save the listing without publication, select tweet 1120 to publish the listing, view 1122 to view the listing in the TWITTER application, delete 1124 to delete the listing from TWITTER, close 1126 to close the interface 1100. When the user selects the tweet button 1120, listing is published as shown in the box 1102. A notification 1116 may also be displayed to inform the user that the listing has been published. The published tweet includes both the user generated content and an automatically generated content. For example, tweet 1102 includes the user's text entered in the text box 1114 (“Grab my latest demo (mp3) track for free”) and an automatically generated text (“Reply “#gimme #demo” to get for $0.00 via @Chirpify pic.twitter.com/photo). Although not shown, the campaign tag “#demo” may be specified directly from the user interface. The live indicator 1130 indicates that the listing is now alive. If the listing was merely saved, the live indicator would not be marked.

When the listing 1102 is published in TWITTER, followers of the user can reply with the action tag “#gimme,” instead of “#buy” to get the listed item for free. When a tweet containing the action tag “#gimme” is detected, the system identifies the tweet as an in-stream transaction with no payment component, and proceeds to fulfill the transaction based on the campaign tag “#demo”. Since the item being listed in the tweet 1102 is a digital content, the system automatically responds to the user who tweeted “#gimme” with a download link. The link may work only for that TWITTER user and/or for a limited time (e.g., 24 hours, 2 days). FIG. 11B shows an example response 1140, including a download link, from the system to the user responding to the listing. If the listing item is a physical item, receipts and messages go out and fulfillment occur just as in an in-stream sale transaction. The details of the transaction may also be accessed by the user who created the campaign and the user responding to the listing from their respective dashboards.

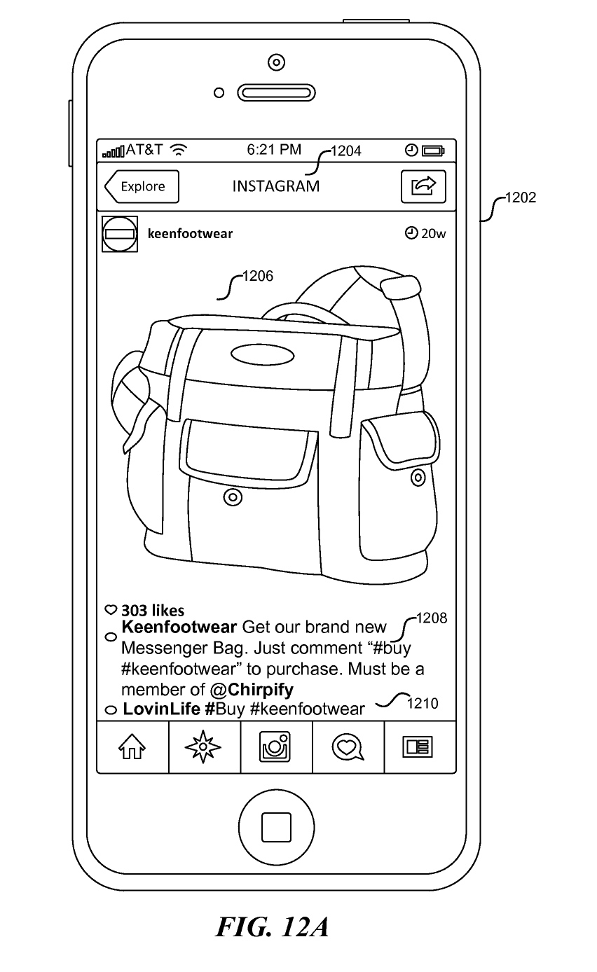

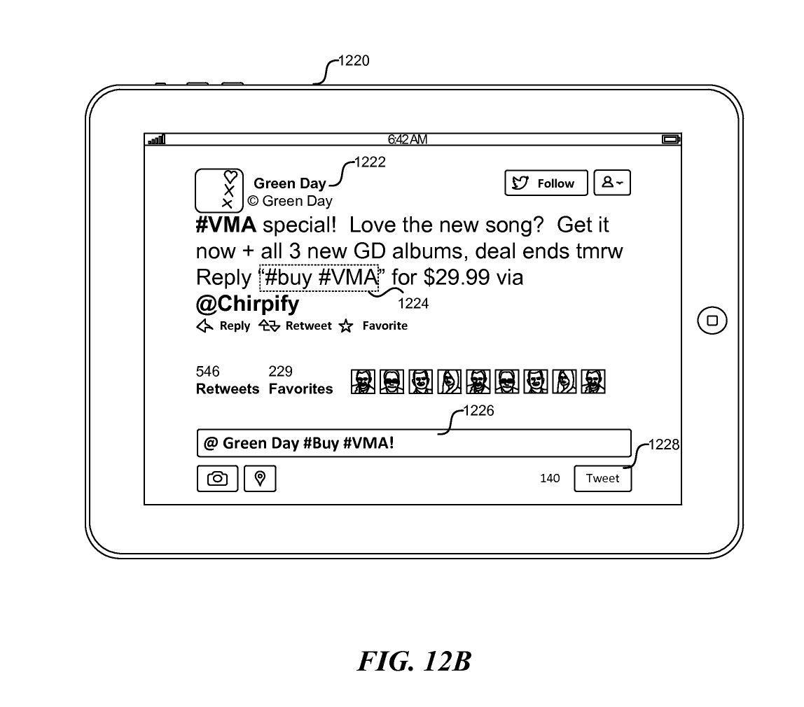

FIGS. 12A and 12B show example interaction with listings on INSTAGRAM and TWITTER respectively. In FIG. 12A, a user “Keenfootwear” has an item listed for sale through an INSTAGRAM post 1208 that includes an action tag “#buy” and a campaign tag “#keenfootwear.” A user “LovingLife” comments “#buy #keenfootwear” 210 to purchase the listed item. The action tag “#buy” triggers the system to complete the transaction with the seller associated with the “Keenfootwear” campaign, without the user having to go through a longer process of visiting the seller's website, logging in or creating an account, adding the item to a shopping cart, checking out. The buying process is simplified into two words. In one embodiment, the transaction is automatically completed if the user “LovinLife” is a member and has authorized the system to process transactions on his or her behalf by linking his or her INSTAGRAM account to the system. If the user is not a member, the user is requested to sign up and provide information such as payment details. The transaction remains unprocessed until the user signs up.

In FIG. 12B, a TWITTER user using a user device 1220 responds to a campaign on TWITTER organized by the user 1222. The campaign has a campaign tag “#VMA” and an action tag “#buy,” and also specifies an amount $29.99. The TWITTER user who wants to purchase the items listed for sale, composes a tweet 1226 that includes the action tag “#buy” and the campaign tag “#VMA” and sends the tweet by selecting the tweet button 1288. The system monitoring the tweets relating to the members, detects the action tag and campaign tag. The system uses the action tag to determine the type of transaction and the campaign tag to identify the associated campaign. The system then automatically completes the purchase transaction and generates and provides receipts and/or notifications through the users' dashboards.

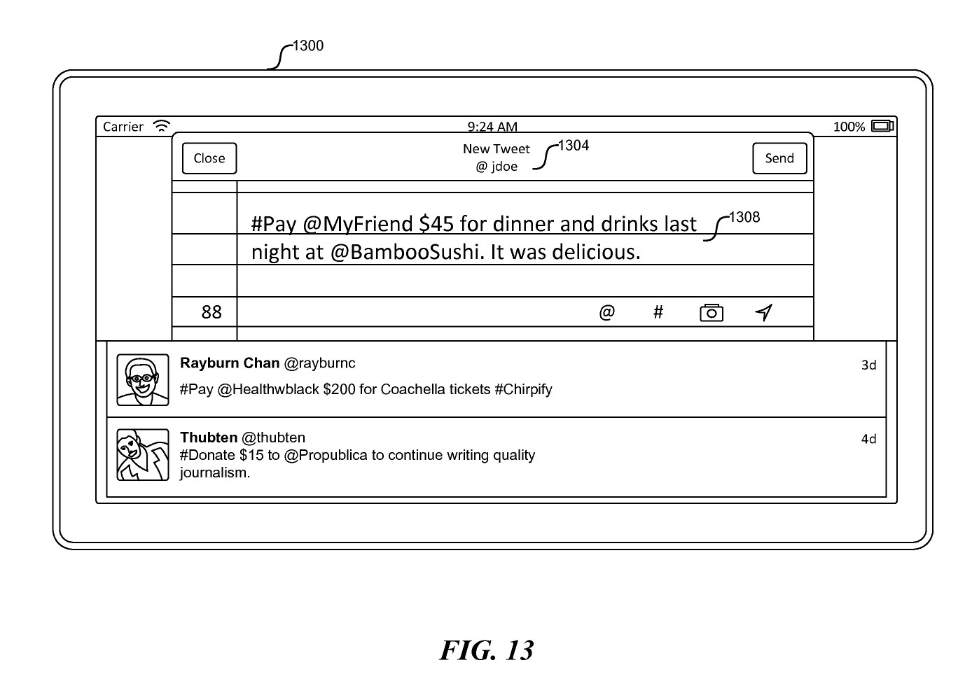

One type of in-stream transaction that the system may process is direct payment or person to person payment transactions. FIG. 13 displays a user interface showing a direct payment tweet on TWITTER accessed from a user device 1300. User 1304 composes a new tweet 1308 to trigger payment to another user. The tweet 1308 includes a “#pay” action tag that is associated with direct payment and is followed by the recipient's TWITTER handle “@MyFriend.” When the tweet 1308 is sent, the system parses the tweet to identify the action tag, the recipient or payee and the amount to be paid ($45 in the example) and automatically completes the transaction by transferring funds from the user 1304's account to the user MyFriend's financial account. If the recipient is not a member, the transaction is not completed until the recipient signs up. In an embodiment, the direct pay transaction requires presence of an action tag (e.g., #pay) and a campaign tag (such as #Chirpify). In this instance, Chirpify would process the payment transaction.

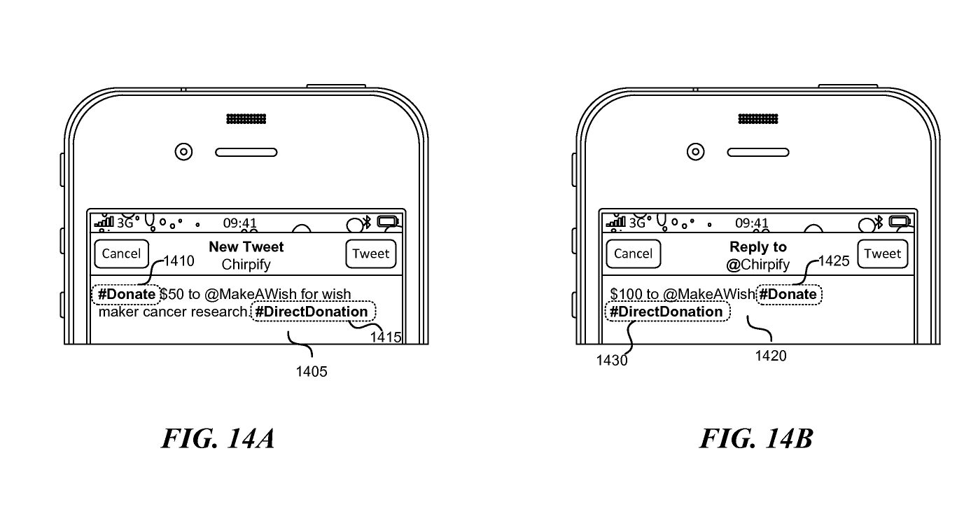

In one embodiment, the system facilitates direct donation that allows a user of a social network service to donate or give to other users of the social network service. For Example, TWITTER users can give or donate to anyone having a TWITTER account. The graphical user interface of FIG. 14A displays a direct donation post on TWITTER from one user to another. To effectuate direct donation, the user composes a tweet 1405 to include the action tag “#donate” 1410 for donation, an amount to be donated, a recipient of the donation (“@MakeAWish”) (may be optional), a reason (optional) and a campaign tag “#DirectDonation” 1415. The system extracts the action and campaign tags from the tweet and automatically completes the in-stream transaction via a payment processor or gateway such that the donor's financial account is debited by the specified amount (plus any fees) and the recipient's financial account is credited by the specified amount. Both the recipient and the donor receive receipts (and tweets in some embodiments) containing information about the transaction in their dashboards. Even if the recipient is not a member, the system captures the transaction for processing. The system automatically responds to the recipient with a sign up link. When the recipient signs up and provides the necessary information, the donation is processed. The user interface of FIG. 14B shows a tweet 1420 where the location of the “#donate” action tag 1425 and the “#DirectDonation” campaign tag 1430 is different from that of tweet 1405 of FIG. 14A. The system does not differentiate between the two tweets and the format of the tweet is flexible.

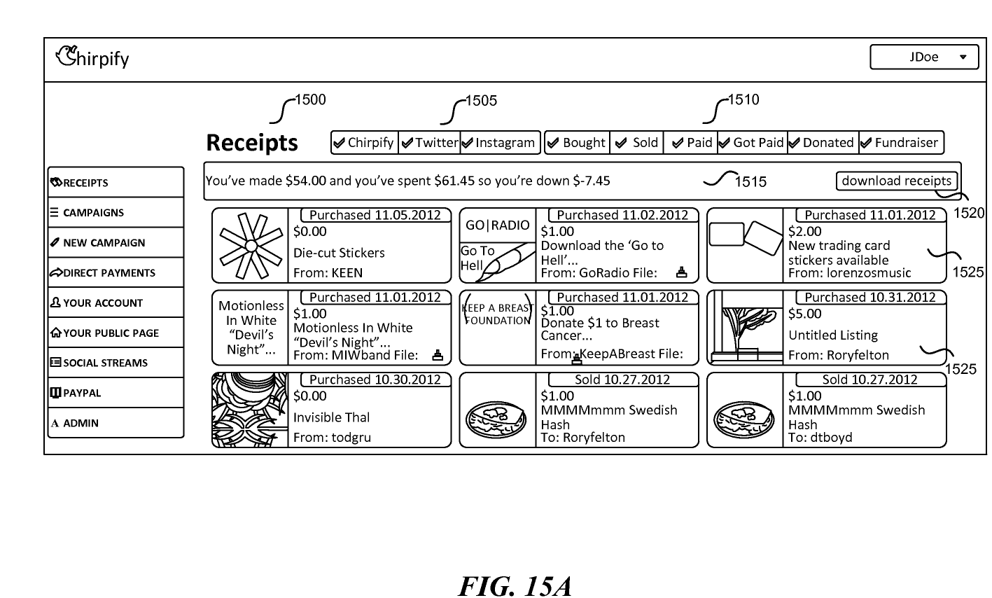

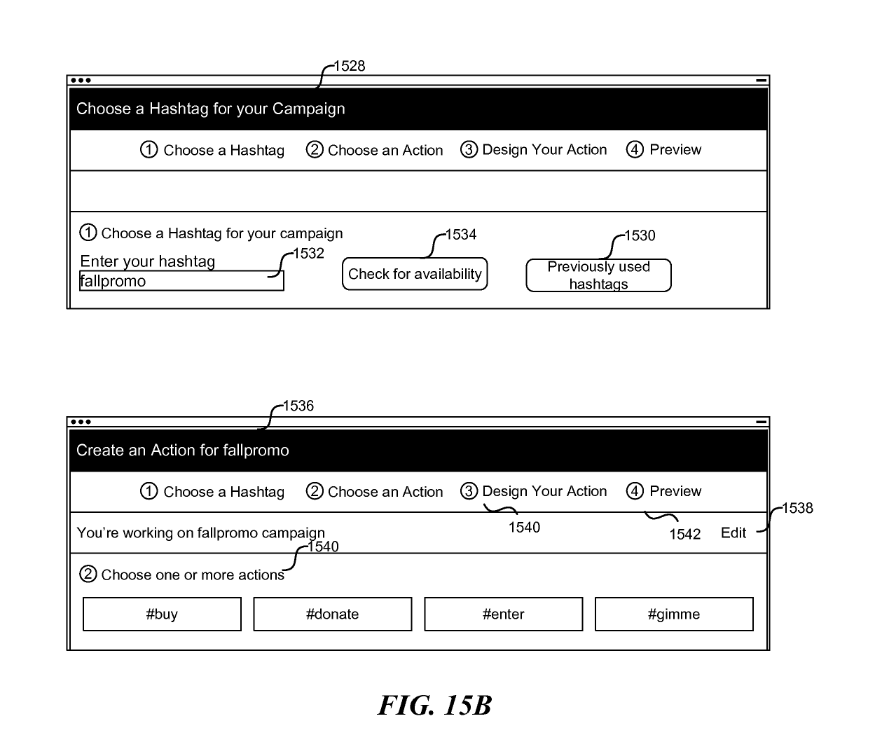

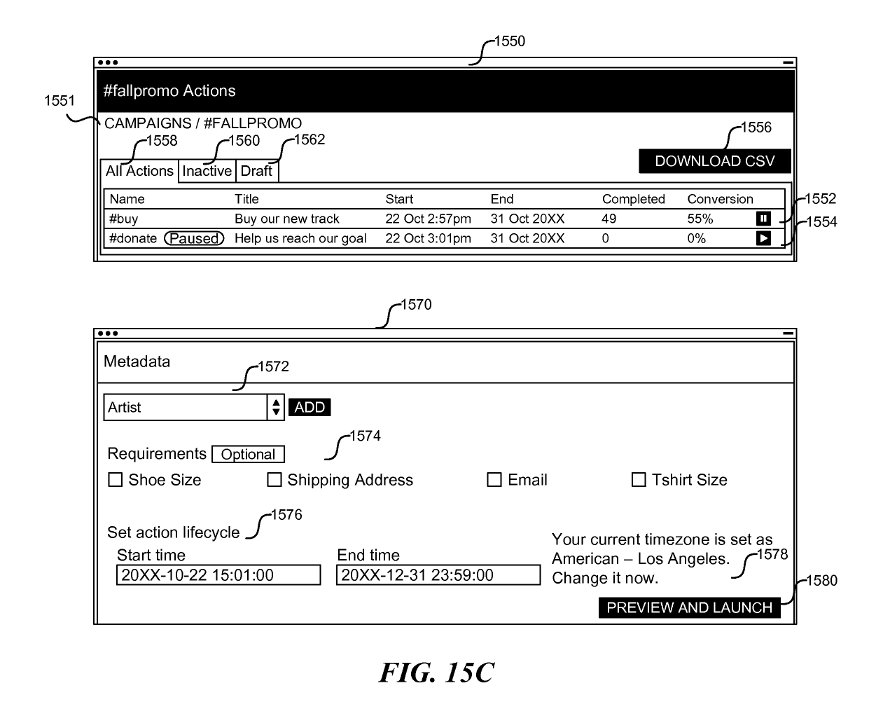

FIGS. 15A-15C are diagrams illustrating graphical user interfaces of a dashboard for managing campaigns and adding meta data to campaigns. In FIG. 15A, an example receipt management interface 1500 of the dashboard for tracking and managing receipts relating to in-stream transactions on one or more social streams is shown. Users can select the social streams 1505 to view receipts from transactions in those streams. Users can also select or deselect any of the tabs 1510 (bought, sold, paid, got paid, donated, fundraiser tabs) to filter out receipts to alter the view. The receipt interface 1500 may also include a summary of total received, total paid, or the like on an informational panel 1520. Any of the displayed receipts 1525 can be individually selected to view or download. The user can also utilize the download receipt button 1520 to download the receipts matching the display criteria (e.g., from tab 1505 and 1510), date range, etc.

Referring to FIG. 15B, the graphical user interface 1528 allows a user to choose or input a campaign tag for a campaign. As shown, the user enters a campaign tag “fallpromo” in the input box 1532 for the campaign. The “check for availability” option 1534 allows the user to see if the campaign tag “fallpromo” is being used in other campaigns in the system. The “previously used hashtags” option 1530 allows the user to view and select a hashtag that was previously used by the user for other campaigns.

Referring to FIG. 15C, the graphical user interface 1536 allows the user to create or associate an action with the campaign “fallpromo.” The user can choose an action from the list 1540 which includes, by way of example only, “#buy,” “#donate,” “#enter” and “#gimme.” The edit option 1538 allows the user to edit the details of the campaign. The “design your action” option 1540 allows the user to create a campaign post or comment for one or more social network services and the “preview” option 1542 allows the user to view the campaign post as it would appear in the one or more social network services.

FIG. 15C shows the graphical user interface 1550 that displays details of the campaign 1551 (“#fallpromo”). Under the “all actions” tab 1558, the user interface displays campaigns 1552, 1554 and details relating to the campaigns. As shown, campaign 1552 is active, and the user interface provides details such as the action tag associated with the campaign, title text, start date, end date, completed (or number of transactions completed) and conversion rate. The user can select the play/pause option to pause or suspend the campaign at any time. As shown, campaign 1554 is paused, but active (according to the start and end dates). Under the “inactive” tab 1550, past campaigns may be displayed. Unpublished or incompletely configured campaigns are displayed under the “draft” tab 1562. The user interface 1550 also shows a download option 1556 that allows the user to download the campaign data in CSV or other suitable format.

The user interface of 1570 allows a user to add meta data to a campaign. For example, the user can select information relating to an item being sold or given away (e.g., artist, song name, make/model) using the menu 1572. The user can also add requirements 1574 such as shoe size, shipping address, email address, t-shirt size, etc., that a transaction participant should specify to complete a transaction. These requirements may be optional, as not all transactions require such information. The user can also set action lifecycle for a campaign 1576 by specifying a start time and an end time and set a time zone 1578 for the campaign. The user can preview and/or launch the campaign using button 1580.

### 6. EXAMPLE API REQUESTS AND RESPONSES

As previously noted, the system website is a client of its own API. The web server 302 and first-party application(s) on user devices such as 324a, 324b (e.g., iOS based devices, Android based devices) make requests of the same API endpoints as third-party service applications. Although only a subset of the APIs may be exposed to third-party service applications (e.g., direct payment, authentication, tweet publish, or other APIs), the exposed APIs can be used by those services to provide frictionless, social and real-time transaction processing capabilities of the system to consumers. Some of the example requests (POST, GET) to API endpoints and example responses (JSON, XML) to the requests are provided below.

Various API calls relating to campaigns, payment, tweets or comments, uploads and users made via HTTP POST or HTTP GET methods will now be described in detail. The base URL in the examples below can be a host such as https://api.chirpify.com/. The API calls may accept one or more parameters including an API key. Responses to the API calls may return status codes (e.g., indicating success or failure), a message body in JSON, XML or other suitable formats, or the like.

An example request to publish (synchronously) listing in the form of a tweet or comment from a campaign may be substantially similar to:

POST campaigns/publish

The request may take as parameters a campaign_ID and an API key and returns a response that includes the newly published listing. The response returned may substantially similar to:

{
“source” : “<a href=\“http://chirpify.com\”
rel=\“nofollow\”>Chirpify Dev</a>”,
“retweeted” : false,
“favorited” : false,
“coordinates” : null,
“place” : null,
“retweet_count” : 0,
“entities” : {
“hashtags” : [ ],
“user_mentions” : [
{
“name” : “ChirpifyDev”,
“id_str” : “526701662”,
“id” : 526701662,
“indices” : [
41,
53
],
“screen_name” : “ChirpifyDev”
}
],
“urls” : [ ]
},
“truncated” : false,
“created_at” : “Tue Aug 14 17:30:17 +0000 2012”,
“in_reply_to_status_id_str” : null,
“contributors” : null,
“text” : “Campaign for RSpec Reply \“buy\” for $1 via
@ChirpifyDev”,
“in_reply_to_user_id” : null,
“user” : {
“id _str” : “492501233”, “id” : 492501233
},
“id” : 235428141668130817,
“in_reply_to_status_id” : null,
“geo” : null,
“in_reply_to_user_id_str” : null,
“id_str” : “235428141668130817”,
“in_reply_to_screen_name” : null
}

An example request to deleting a campaign (which may also remove the listing from the social network services where it is published) may be substantially similar to:

POST /campaigns/delete

The request takes a campaign_ID, user_ID or username and API key as parameters and returns a response that includes a hash containing text if successful. The response may be substantially similar to:

{
“message” : “Campaign deleted”
}

An example request for fetching details of a campaign may be substantially similar to:

POST https://api.chirpify.com/campaigns/lookup

The request accepts a campaign_ID, tweet or comment_ID or digital_content_ID and an API key as parameters. A response to the request above includes a hash and may be substantially similar to:

{
“imported_id” : null,
“date” : “2012-06-07 18:19:17”,
“photo” : “7b6c4170d2053dfeae5ca1cf0cbad088.jpg_1000_1000.jpg”,
“meta” : [ ],
“partner_id” : “0”,
“shipping_price” : “0.00”,
“id” : “10”,
“fulfillment_url” : null,
“digital_content_id” : null,
“tweet_id” : “235428141668130817”,
“quantity” : “1”,
“active” : “1”,
“digital_file_name” : null,
“schedule_hours” : “0”,
“description” : null,
“is_donation” : “0”,
“is_promo” : “0”,
“shipping_days” : “1”,
“price” : “1”,
“user_id” : “19”,
“tweet_text” : “Campaign tweet text”,
“unlimited_quantity” : “1”
}

An example request for creating a new blank campaign that takes a user_ID or username and an API key as parameters may be substantially similar to:

POST /campaign/new

A response to the above request includes details of the campaign and may be substantially similar to:

{
“imported_id” : null,
“date” : “2012-08-14 12:22:09”,
“photo” : “twitter_avatar.jpg”,
“meta” : [ ],
“partner_id” : “0”,
“shipping_price” : “ ”,
“user” : {
“profile” : {
“sales_percentage” : “0”,
“email_news” : “1”,
“city” : “Portland”,
“account_level” : “enterprise”,
“id” : “15”,
“address” : “731 se 47th ave.”,
“email_receipts” : “1”,
“followers” : null,
“country” : “US”,
“twitter_receipts” : null,
“klout” : null,
“name” : “chris teso”,
“address2” : “ ”,
“zip” : “97215”,
“state_province” : “OR”,
“user_id” : “15”
},
“paypal_email” : “paysoc_1327541410_per@sellsimp.ly”,
“has_promos” : false,
“active” : “1”,
“twitter_uid” : “415839284”,
“avatar_url” :
“http://a0.twimg.com/profile_images/2249611942/avatar_normal.jpg”,
“secret” : “nW4EnXRKouFiz4Sss5sDBCJK7GpZVz8Lnd2p4FQbg”,
“username” : “chirpfiy”,
“paypal_token” : “PA-8R762936YY763193U”,
“is_admin” : “0”,
“id” : “15”,
“token” :
“415839284-MPbFwPifzWTV62BT1K2YLUimynpnUHUfA7Dv5HkH”
},
“id” : “74”,
“fulfillment_url” : null,
“digital_content_id” : null,
“tweet_id” : null,
“quantity” : “1”,
“active” : “0”,
“digital_file_name” : null,
“schedule_hours” : “0”,
“description” : “ ”,
“is_donation” : “0”,
“is_promo” : “0”,
“shipping_days” : “1”,
“price” : “1”,
“user_id” : “15”,
“tweet_text” : “ ”,
“unlimited_quantity” : “1”
}

An example request for adding meta data to a campaign may be substantially similar to:

POST /campaigns/meta

The request takes a user_ID or username, an API key and a campaign_ID as parameters and returns a response that includes meta data associated with the campaign. The response may be substantially similar to:

{
“imported_id” : null,
“date” : “2012-06-07 18:19:17”,
“photo” : “7b6c4170d2053dfeae5ca1cf0cbad088.jpg_1000_1000.jpg”,
“meta” : [
{
“value” : “10”,
“id” : “116”,
“key” : “campaign_id”,
“campaign_id” : “10”
},
{
“value” : “19”,
“id” : “117”,
“key” : “user_id”,
“campaign_id” : “10”
}
],
“partner_id” : “0”,
“shipping_price” : “0.00”,
“id” : “10”,
“fulfillment_url” : null,
“digital_content_id” : null,
“tweet_id” : “235428141668130817”,
“quantity” : “1”,
“active” : “1”,
“digital_file_name” : null,
“schedule_hours” : “0”,
“description” : null,
“is_donation” : “0”,
“is_promo” : “0”,
“shipping_days” : “1”, “price” : “1”,
“user_id” : “19”,
“tweet_text” : “Campaign for RSpec”,
“unlimited_quantity” : “1”
}

An example request for updating an existing campaign may be substantially similar to:

POST /campaigns/update

The request takes as parameters a user_ID or username, an API key and an ID. The API request may optionally include as parameters digital_content_ID, digital_file_name, fulfillment_url, image_url, price, quantity (integer), schedule_hours, shipping_days, shipping_price, tweet_text, description, unlimited_quantity. The request may return updated information relating to the campaign and may be substantially similar to:

{
“imported_id” : null,
“date” : “2012-06-07 18:19:17”,
“photo” : “7b6c4170d2053dfeae5ca1cf0cbad088.jpg_1000_1000.jpg”,
“meta” : [
{
“value” : “10”,
“id” : “116”,
“key” : “campaign_id”,
“campaign_id” : “10”
},
{
“value” : “19”,
“id” : “117”,
“key” : “user_id”,
“campaign_id” : “10”
}
],
“partner_id” : “0”,
“shipping_price” : “0.00”,
“id” : “10”,
“fulfillment_url” : null,
“digital_content_id” : null,
“tweet_id” : null,
“quantity” : “1”,
“active” : “1”,
“digital_file_name” : null,
“schedule_hours” : “0”,
“description” : “0”,
“is_donation” : “0”,
“is_promo” : “0”,
“shipping_days” : “1”,
“price” : “1”,
“user_id” : “19”,
“tweet_text” : “Campaign for RSpec”,
“unlimited_quantity” : “1”
}

An example request to make a payment via a financial account (e.g., PAYPAL) for a direct tweet through a POST request may be substantially similar to:

POST /pay/direct

The request accepts as parameters an API key, tweet_ID, amount, payee_username and a payer username. The request may optionally accept a reason or description of payment transaction as a parameter. The request returns as response an error ID and/or error message if the payment is unsuccessful and an indication of success if the payment is successful.

An example API request to make a payment through a financial account for a donation or campaign through a POST request may be substantially similar to:

POST https://api.chirpify.com/pay/campaign

The request includes as parameters an API key, a tweet ID, a reply to tweet ID or campaign ID, an amount, a payee user name (e.g., TWITTER username for payment recipient) and a payor username (e.g., TWITTER username for paying party). The requests may return a collection of properties relating to a buyer (or payer), a seller (payee) and the campaign in the response.

An example API request to parse a tweet or comment to see if the tweet or comment contains action tags and/or campaign tags may be substantially similar to:

POST /tweet/parse

The request takes an API key and a tweet or comment as parameters and returns a response that may include a payer ID (e.g., TWITTER username), a payee ID (e.g., TWITTER username), an amount, a reason, an action tag and/or a campaign tag.

An example API request to publish a tweet or comment may be substantially similar to:

POST /tweets/publish

The request takes as parameters a username or user ID, a tweet or comment text and an API key, and returns a response that may include information such as:

contributors
coordinates
created_at
entities
favorited
geo (or location)
id
id_str
in_reply_to_screen_name
in_reply_to_status_id,
in_reply_to_status_id_str
in_reply_to_user_id
in_reply_to_user_id_str
place
retweet_count
retweeted
source
truncated
user

An example API request to delete a tweet, comment or listing with a specific ID for a user may be substantially similar to:

POST /tweets/delete

The response content may return a Boolean (true or false).

An API request for uploading a uniquely named file to an online or remote file storage (e.g., Amazon Simple Storage Service S3) may be substantially similar to:

POST /upload/new

The API request takes as parameters the content (e.g., Base 64 encoded string that represents the content of the file to be uploaded), a filename (e.g., generated from the SHA-1 of the contents of the file) and a user ID. The request returns a hash and the content of the response includes an s3_ID or other identifier.

An API request to fetch an enumerated list of desired contact methods for a user may be substantially similar to:

GET /users/receipt_methods

The request accepts a user ID or username and an API key and returns an array that may be substantially similar to:

[
“twitter”, “email”
]

An example API request to fetch all information supplied by a user may be substantially similar to:

GET /users/lookup

The request accepts a user ID or username and an API key as parameters and returns an array of user properties depending on access level. An example response returned may be substantially similar to:

{
“profile” : {
“city” : “St Louis”,
“address” : “900 Street”,
“followers” : “1”,
“country” : “US”,
“name” : “Chirp Demo A US”,
“address2” : “ ”,
“zip” : “60601”,
“state_province” : “MO”
},
“twitter_uid” : “637231315”,
“avatar_url” :
“http://a0.twimg.com/sticky/default_profile_images/default_profile_
0_normal.png”, “username” : “CHIRP_DEMO_A_US”,
}

An example API request to getch a list of states saved in the database may be substantially similar to:

GET /users/states

The request includes an API key as a parameter and returns an array of states. An example response returned may be substantially similar to:

[
{
“abbrev” : “AK”,
“name” : “Alaska”,
“id” : “1”
},
{
“abbrev” : “AL”,
“name” : “Alabama”,
“id” : “2”
},
{
“abbrev” : “AS”,
“name” : “American Samoa”,
“id” : “3”
},
{
“abbrev” : “AZ”,
“name” : “Arizona”,
“id” : “4”
},
{
“abbrev” : “AR”,
“name” : “Arkansas”,
“id” : “5”
},
{
“abbrev” : “CA”,
“name” : “California”,
“id” : “6”
},
{
“abbrev” : “CO”,
“name” : “Colorado”,
“id” : “7”
}
]

### 7. EXAMPLES OF FIRST-PARTY OR THIRD-PARTY APPLICATIONS

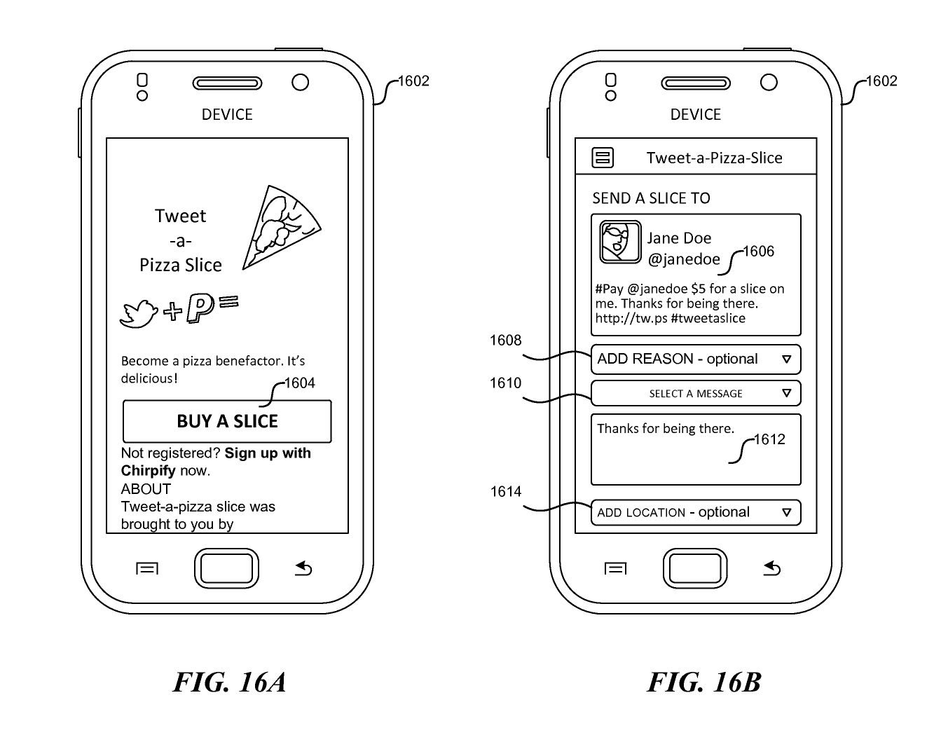

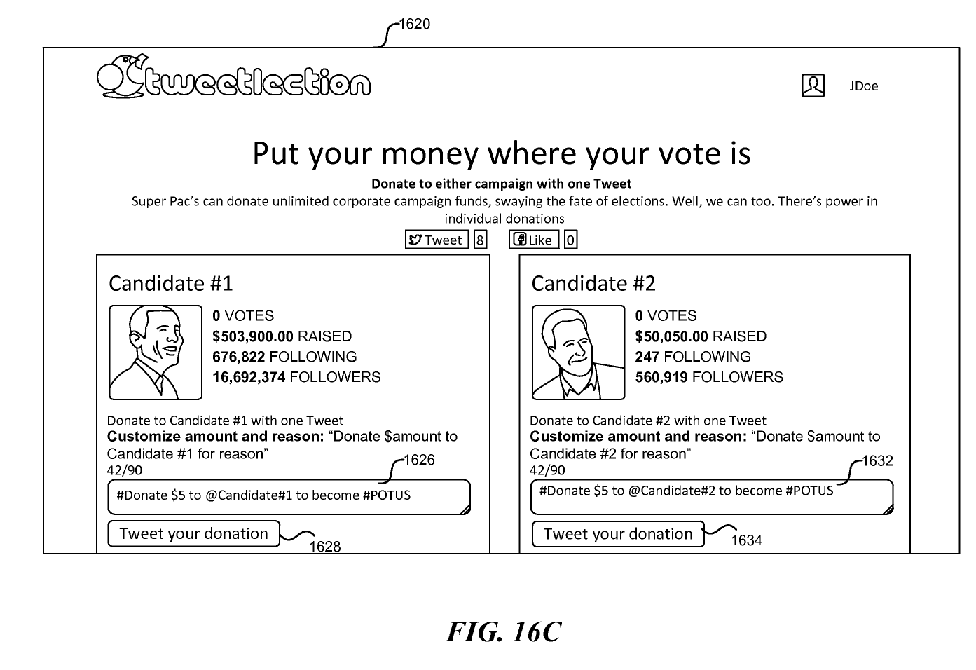

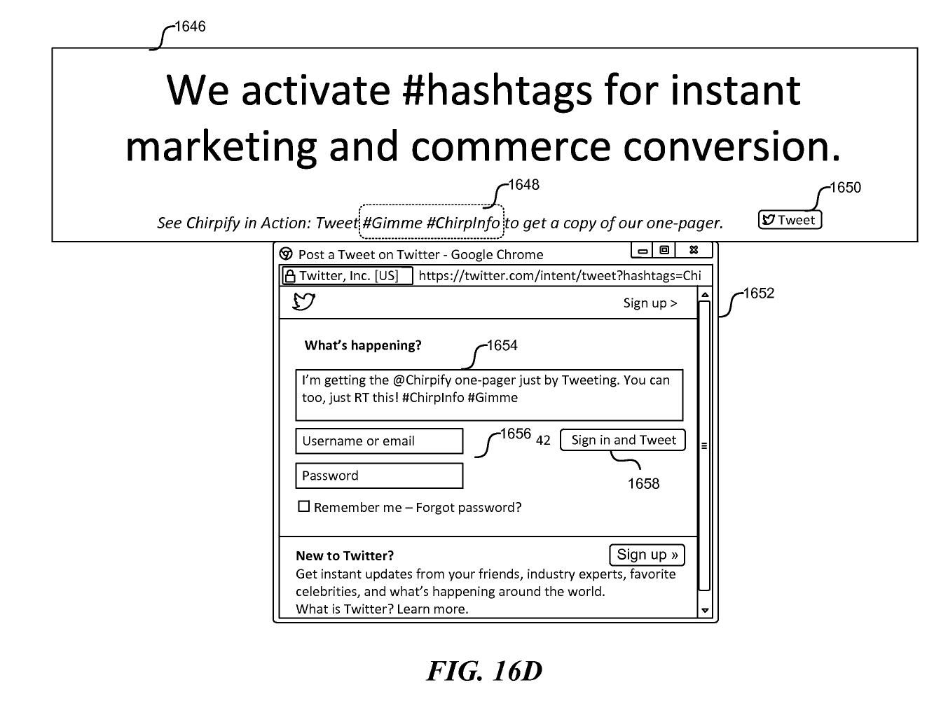

An example application leveraging the exposed APIs includes an application that allows a user to buy an item (e.g., pizza slice) over TWITTER. Example graphical user interfaces of the application on a mobile device 1602 are shown in FIGS. 16A-B. The application also allows the user to choose a recipient, a merchant or location, an amount or number, include a message, and/or the like to engage in geo-targeted TWITTER-based conversational commerce. Referring to FIG. 16A, the user interface includes a button “Buy a slice” 1604 that can be selected by a user to launch the user interface of FIG. 16B. The user interface of FIG. 16B includes an option to select or enter the handle of the recipient 1606 to whom the pizza slice is to be sent. The user interface also includes an option to add a reason 1608 or select or enter a message 1610. The message 1612 that is entered, selected or edited by the user is inserted or appended to an automatically generated message portion that includes an action tag (“#pay”), a campaign tag (“#tweet a slice”), recipient (“@janedoe”), amount (“$5”) and link (“http://tw.ps”). The user can also add a location 1614, where the amount can be used to buy the pizza slice to utilize geo-targeting to direct consumers to specific locations, merchants, etc.

A second example includes an application that randomly (or systematically) searches TWITTER (or any other social network service) for users conversing about an item, brand, theme, or the like (e.g., restaurants, clothes, concert, artist, television show). The topic of conversation may be featured on a TV show, radio, print, or media channel. The application then sends those select users money, offers/deals, freebies, etc., using the APIs exposed by the in-stream transaction processing system.

A third example includes an application that uses payment as a negative punishment to motivate users to stick to their goals. For example, a user can use the application to set up a goal and who and how much to pay if the user fails. If the user fails in his goal, the application notifies the user of the failure and uses the exposed APIs to process the payment to one or more users. The system sends a tweet on the user's behalf to complete the payment transaction.

A forth example includes an application (or website) that allows political or government office candidates to raise money for and donors to contribute to campaigns via social network services such as TWITTER using a comment, message, post or tweet. The application allows donors to give and track donations to candidates. Referring to FIG. 16C, the graphical user interface 1620 of the application displays, for each candidate, a text box (1626, 1632) for a user to enter or edit a tweet matching a format (e.g., #donate $amount to @candidate_handle custom_message #campaign tag) and “tweet your donation” button (1628, 1634) to initiate the transaction. The application can also include one or more buttons for one or more denominations customized to donate certain amounts of funds to a candidate. The user can complete the donation process with a single click or tap of one of the buttons. The in-stream transaction processing system detects and parses the tweet and completes the transaction as requested. If the candidate who is receiving the funds is not a member, the system can continue to collect the funds on his or her behalf until the candidate signs up and becomes a member. Once the candidate signs up, the candidate can access his or her dashboard to view and/or download donor data to keep track of donations.

A fifth example application of the in-stream transaction processing system is shown in FIG. 16D. E-commerce or any other websites or applications can integrate in-stream transaction processing capabilities into their sites to extend their offerings on social networks such as TWITTER. For example, a button 1650 (or other widget) can be customized and added to a website 1646. When the button 1650 is selected, a pop up window 1652 is displayed. The window 1652 includes a text box 1654 with auto-generated text including an action tag and campaign tag 1648 associated with the button 1650. A user can edit the text in the text box 1654, enter user credentials 1656 and select sign in and tweet button 1658 to send the tweet in the text box 1648. In this example, the transaction is for requesting a one pager from the user “@Chirpify.” The system identifies the transaction as involving no payment (i.e., non-financial or non-monetary transaction) and retrieves and sends the one pager to the requesting user.

Similarly, in another example application, the in-stream transaction listing capabilities of the system can be integrated into e-commerce storefront programs or e-commerce websites to allow merchants to click on a listing button (e.g., “list on TWITTER” button) to instantly create a campaign and distribute a listing i through media channels. Selecting the listing button triggers export of information relating to one or more items to the in-stream transaction processing system, which in response, creates a campaign based on the received information. The merchant may then access the system website to select distribution channels and/or configure or customize a listing associated with the campaign. The merchant may also data relating to engagement with the listing that are aggregated and/or processed by the system. For example, for a campaign to sell an item, the system can track number of retweets, favorites, shares or the like of the listing, determine an engagement rate, a conversion rate, number of “buy” responses to the listing, determine sales over a period of time, and the like.

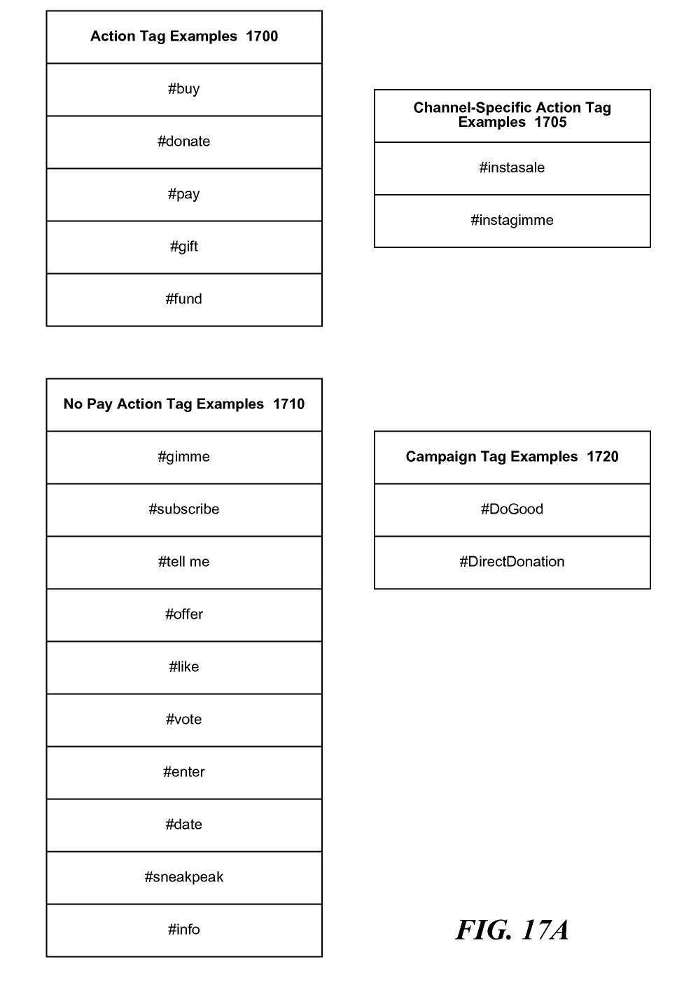

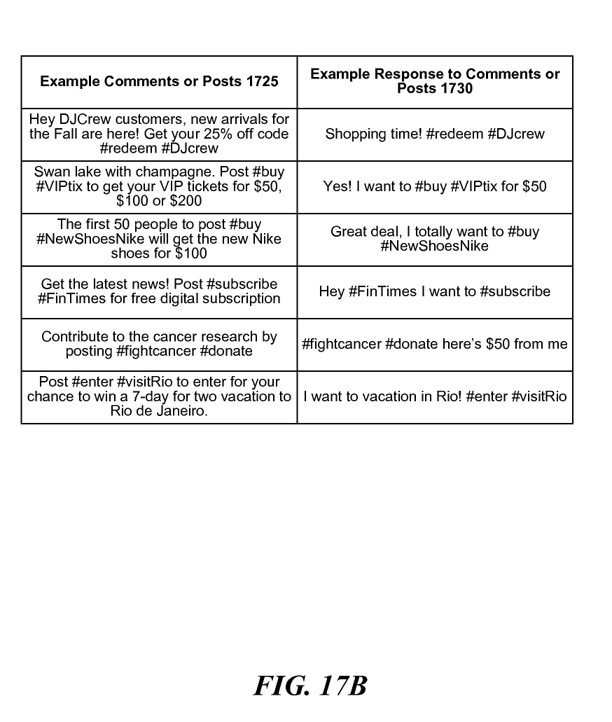

FIGS. 17A-B are tables illustrating examples of action tags and campaign tags in the in-stream transaction processing system. Table 1700 lists examples of action tags, each of which are associated with and trigger certain types of transactions that are handled by the system accordingly. For example, presence of “buy” action tag in a comment is an indication that the comment is related to a purchase transaction, which triggers the system to complete the transaction by notifying the seller to fulfill the order and by charging an amount corresponding to the item being bought to the buyer's financial account. Similarly, the action tag “gift” in a comment along with a recipient name is an indication that the comment is associated with a gifting transaction where the commenting user is purchasing an item as a gift to the recipient identified in the comment. Based on this recognition, the system completes a transaction where the commenting user's financial account is charged the cost of the gift item, and the seller is notified to fulfill the order by sending the gift item to the recipient. Similarly, using the “fund” action tag and specifying an amount of money, a user can fund a project. The funding from various users to the project can be tracked by the system so that the users who funded the project can get some return on investment should the project be successful.

Table 1705 lists examples of channel-specific action tags that can be used to create a campaign. For example, using the action tag “#instasale,” a user can convert an INSTAGRAM post into a campaign for sale. Buyers can then simply comment “buy” to purchase the item being listed. Similarly, by tagging a picture of an item on INSTAGRAM with “#instagimme” converts the INSTAGRAM post into a campaign with no pay component. Other users can then comment “gimme” to obtain the listed item for free.

Table 1710 lists examples of no pay action tags. No pay action tags do not trigger payments. For example, the action tag “gimme” can be used in a comment to get a giveaway item for free. Similarly, the action tag “subscribe” can be used in a comment to join or subscribe to a free newsletter, magazine, emails, etc. Table 1720 lists examples of campaign tags that can be activated for campaigns for a limited or unlimited period of time. For example, a campaign to raise funds for the Stand Up to Cancer Program can activate the campaign tag “#DoGood.” Users can donate to the campaign by posting a comment that includes the action tag for donate “#Donate” and the campaign tag for the campaign “#DoGood.”

FIG. 17B is a table illustrating examples of campaigns 1725 and responses from consumers 1730 that trigger in-stream transactions. As shown, the campaigns relate to discount coupon giveaway, VIP tickets for sale, subscribing to digital content, donation and entering into a sweep stake.

### 8. CONCLUSION

Those skilled in the art will appreciate that the actual implementation of a data store may take a variety of forms, and the phrase “data store” is used herein in the generic sense to refer to any area that allows data to be stored in a structured and accessible fashion using such applications or constructs as databases, tables, linked lists, arrays, and so on.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times.

In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

What is claimed is:

1. A computer-implemented method of identifying a user message on a social network as a request to process a transaction, comprising:
monitoring user messages on a social network;
determining that a user message from the messages includes a system-defined tag and a user-defined tag, wherein the system-defined tag is a desired command and the user-defined tag is an identifier of a user-specified campaign; and
identifying the user message having the system-defined and user-defined tags as a request to process a transaction.

2. The method of claim 1, further comprising:
determining whether the request meets one or more conditions for processing the transaction.

3. The method of claim 2, wherein the one or more conditions for processing the transaction includes identification of a user account associated with a creator of the user message.

4. The method of claim 3, wherein the transaction is identified as a financial transaction based on the system-defined tag, and the one or more conditions for processing the financial transaction includes identification of a payment account associated with the user account.

5. The method of claim 3, wherein the transaction is identified as a non-financial transaction based on the system-defined tag.

6. The method of claim 2, further comprising, when the request fails to meet the one or more conditions for processing the transaction, suspending the transaction until the one or more conditions are met.

7. The method of claim 2, further comprising:
processing the transaction based on at least the system-defined tag and the user-defined tag determined from the user message when the request meets the one or more conditions for processing the transaction.

8. The method of claim 7, wherein when the system-defined tag is a buy command, processing the transaction further comprises:
using payment information associated with parties engaging in the transaction to execute a purchase transaction between the parties.

9. The method of claim 8, wherein the purchase transaction involves purchase of physical goods, services or digital content.

10. The method of claim 7, wherein when the system-defined tag is a pay command, processing the transaction further comprises:
using payment information associated a creator of the user message and a recipient specified in the user message to transfer funds from a payment account of the creator of the user message to that of the recipient.

11. The method of claim 7, further comprising:
determining that the transaction is a giveaway transaction based on the system-defined tag and the user-defined tag; and
wherein the processing includes facilitating fulfillment of an item associated with the giveaway transaction by delivering the item to a creator of the user message or notifying a party associated with the user-defined tag to deliver the item to the creator of the user message.

12. The method of claim 1, wherein the system-defined tag is one of a plurality of commands that are system-defined.

13. The method of claim 1, wherein the user-defined tag is one of a plurality of identifiers that are user-defined.

14. The method of claim 1, wherein the user message on the social network is responsive to a message on a media channel, wherein the media channel includes the social network, another social network, radio, print or television.

15. The method of claim 1, wherein at least a portion of the user message including the system-defined tag and the user-defined tag is automatically generated in response to a user interaction with a widget on a website or application.

16. A system for processing a user message on a social network as a transaction, comprising:
a memory storing computer-executable instructions; and
a processor disposed in communication with the memory and configured to process the computer-executable instructions to:
detect a user message from a user on a social network;
parse the user message to extract an action command and an identifier of a campaign;
based on the action command and the identifier, process a transaction on the user's behalf; and
generate and provide a receipt corresponding to the transaction to the user.

17. The system of claim 16, wherein the transaction that is processed is a financial transaction when the action command is one of a buy command, pay command, donate command or fund command.

18. The system of claim 16, further comprising instructions to notify a party associated with the identifier of a campaign to fulfill an order associated with the transaction.

19. The system of claim 16, further comprising instructions to fulfill an item associated with the identifier of a campaign by electronically delivering the item to the user.

20. The system of claim 16, further comprising instructions to monitor a plurality of social networks including the social network for user messages from a plurality of users.

21. The system of claim 16, further comprising instructions to aggregate the receipt corresponding to the transaction on the social network along with any other receipts corresponding to other transactions on the same social network or other social networks for user access via a dashboard.

22. The system of claim 16, further comprising instructions to receive a notification from the social network regarding a new activity associated with the user or receive real-time activity data streamed from the social network.

23. A computer-implemented method for creating a campaign for publication on a social network, comprising:
receiving from a user interface information relating to a campaign;
receiving a campaign identifier for the campaign;
receiving a selection of an action command from a plurality of action commands, wherein the selection is based on a type of transaction that the campaign is configured to trigger;
receiving a selection of at least one social network;
creating the campaign based on the received information, the campaign identifier and the action command received from a user; and
publishing on the at least one social network on the user's behalf, a first message that includes the campaign identifier and the action command corresponding to the campaign.

24. The method of claim 23, wherein publication of the first message including the campaign identifier and the action command on the at least one social network triggers monitoring of messages on the social network to identify a second message that includes at least the campaign identifier and the action command.

25. The method of claim 24, wherein in response to identifying the second message that includes at least the campaign identifier and the action command, processing a transaction in accordance with the second message.

26. The method of claim 23, further comprising providing a user interface to track and manage the campaign associated with a user account.

27. The method of claim 23, wherein the campaign is related to a sale campaign and the information relating to the campaign includes meta data relating to an item for sale and duration of the campaign.

28. A client computing system for triggering a transaction via a comment, comprising:
a component of a mobile application or a web browser configured to receive a comment that includes an action tag and a campaign tag from a user and send the comment along with an identifier of the user to a first server system to trigger the first server system or a second server system to complete a transaction on the user's behalf.

29. The client system of claim 28, wherein the first server system is associated with a social network service and the second server system is a transaction processing server system.

30. The client system of claim 29, wherein the action tag is used to identify a type of transaction to be completed, the campaign tag is used to locate information relating to a campaign and an account associated with the campaign and the user identifier is used to obtain information relating to the user.
